(19) United States
(12) Patent Application Publication
(10) Pub. No.: US 2025/0354031 A1
(43) Pub. Date: Nov. 20, 2025

(54) Transparent Omniphobic Coatings

(71) Applicant: Queen's University at Kingston, Kingston (CA)

(72) Inventors: Guojun Liu, Kingston (CA); Desiree Bender, Kingston (CA); Ziruo Lai, Kingston (CA); Rachel Shum, Markham (CA); Adam Wolpert, Kingston (CA)

(21) Appl. No.: 18/865,786

(22) PCT Filed: May 30, 2023
(86) PCT No.: PCT/CA2023/050738

§ 371 Date: Nov. 14, 2024

Related U.S. Application Data
(60) Provisional application No. 63/346,938, filed on May 30, 2022.

(51) Int. Cl. C09D 183/08; C08G 77/14; C09D 5/16; C09D 183/10

(52) U.S. Cl. CPC C09D 183/08; C08G 77/14; C09D 5/1675; C09D 183/10

(57) ABSTRACT

Transparent rollable omniphobic coatings are described that have exceptional hardness and wear resistance. The coatings have facile preparation. They are highly transparent and substrate can undergo inward bending on the inner side of a bend to radii <1 mm without cracking. The polymer can be deposited in a single step to yield a coating that serves the dual function of an anti-smudge layer and a bendable protective layer with glass-like hardness and polymer-like flexibility.

### RELATED APPLICATION

This application claims the benefit of the filing date of U.S. Application No. 63/346,938, filed on May 30, 2022, the contents of which are incorporated herein by reference in their entirety.

### FIELD

The field of this invention is coatings. More specifically, the field is flexible coatings that repel water and oil, and have hardness greater than 1 GPa.

### BACKGROUND

Screens and surfaces of cell phones, tablets, and other hand-held electronic devices are susceptible to fingerprints and smudge deposition. A touchscreen of a foldable smartphone needs protection by a hard yet rollable anti-smudge anti-fingerprint layer. A colorless polyimide film is currently used as protective layer. While organic polymers can be flexible, they normally have nanoindentation hardness (H) below 0.4 GPa. To overcome this challenge, cellphone manufacturers are actively seeking rollable coatings with improved wear resistance. Glass is rollable when its thickness is reduced to tens of micrometers, or to micrometers. However, thin glass is susceptible to scratching and defects propagate from these scratches, causing failure upon bending.

### SUMMARY

In one aspect, the invention provides a polymer of formula 1

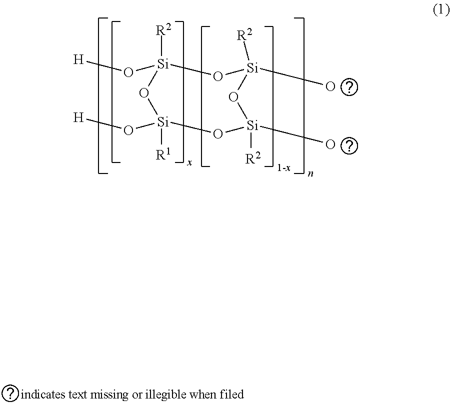

where n is 1 to 1000, x is 0.01 to 1, R¹ comprises a liquid-like moiety, and
R² comprises a crosslinkable moiety.

In an embodiment, n is 1 to 100. In an embodiment, R¹ comprises perfluorinated poly(propylene oxide), poly(dimethyl siloxane) (PDMS), dodecyl, perfluorinated hexyl, iso-dodecyl, poly(N,N-dimethylamino methacrylate)-g-PDMS, oligo (ethylene oxide), poly(2-ethylhexyl macrylate), polyisobutylene, or a combination thereof. In one embodiment, poly(N,N-dimethylamino methacrylate) (PDMAEMA) after quaternization is an antimicrobial agent. In an embodiment, R² comprises epoxide, vinyl, acrylate, methacrylate, aryl, heteroaryl, vinyl, aziridine, amino, carboxy, hydroxy, thiol, anhydride, phosphino, silane (SiH), or a combination thereof.

In one aspect, the invention provides a cured coating, comprising ladder-like polysilsesquioxane (LASQ) that bears a liquid-like moiety. In one aspect, the invention provides a cured coating precursor comprising the compound of Formula 1, and LASQ (i.e., where LASQ is ladder-like polysilsesquioxane that does not bear a liquid-like moiety. In an embodiment, the coating is highly transparent. In an embodiment, the coating is omniphobic. In an embodiment, the coating is wear resistant. In an embodiment, the coating has high hardness. In an embodiment, the coating is flexible. In an embodiment, the coating comprises PDMS, LASQ prepared from 2-(3,4-epoxycyclohexyl)ethyltrimethoxysilane, (3-glycidyloxypropyl) trimethoxysilane, 3-methacryloypropyl trimethoxysilane, or a combination thereof. In an embodiment, the coating has a F mass fraction in a range of 0.1% to 20%. In an embodiment, the fluorine mass fraction is about 6%. In an embodiment, the coating has a surface energy of about 5 to about 40 mJ/m². In an embodiment, the surface energy is about 12 mJ/m².

In one aspect, the invention provides an uncured coating precursor comprising the compound of Formula 1, and, optionally, LASQ (i.e., where LASQ is ladder-like polysilsesquioxane) that does not bear a liquid-like moiety.

In one aspect, the invention provides an article comprising the cured coating of any one of the above aspects of embodiments. In an embodiment, the article comprises a screen, smartphone, tablet, monitor, television, display screen, windshield, musical instrument, solar cell, automotive body, doors, metal doors, household appliances, eyeglasses, drinking glasses, lenses, scientific and medical instruments, furniture, dining tables, chairs, sofa, power line, surveillance equipment, surveillance camera, blades of a wind turbine, solar cell panels, or wings of an airplane.

In one aspect, the invention provides a method of making the coating of any one of the above aspects or embodiments, wherein LASQ is reacted with a limiting reactant that bears a liquid-like moiety. In an embodiment, the coating comprises LASQ derived from isobutyltrimethoxysilane, n-propyltrimethoxysilane, hexyltrimethoxysilane, cyclohexyltrimethoxysilane, phenyltrimethoxysilane, PDMS bearing a terminal trimethoxysilyl group, perfluorinated polyether (PFPE) bearing a terminal trimethoxysilyl group, perfluorododecyltrimethoxysilane, perfluorotridecyltrimethoxysilane, perfluorodecyltrimethoxysilane, perfluorooctyltrimethoxysilane, decyltrimethoxysilane dodecyltrimethoxysilane, isododecyltrimethoxysilane, 2-(3,4-epoxycyclohexyl)ethyltrimethoxysilane, (3-glycidyloxypropyl) trimethoxysilane, (3-methacryloxypropyl) trimethoxysilane, (3-acryloxypropyl) trimethoxysilane, (3-aminopropyl) trimethoxysilane, or a combination thereof.

In one aspect, the invention provides a method of making an uncured ladder-like polysilsesquioxane that is crosslinkable and has a liquid-like moiety, comprising reacting in the presence of water and base catalyst, a monomer of formula R¹Si(OR^{Sac})₃, wherein R¹ is a liquid-like moiety, and R^{sac} is a sacrificial moiety, with a monomer of formula R²Si(OR^{sac})₃, wherein R² is a crosslinkable moiety, to provide a bifunctional polymer with uncapped ends; and adding in excess, trimethylsilyl halide, trialkylsilyl halide, or triarylsilyl halide to provide a bifunctional polymer with capped ends, wherein the bifunctional polymer is an uncured ladder-like polysilsesquioxane that is crosslinkable and has a liquid-like moiety.

In one aspect, the invention provides a method of making cured ladder-like polysilsesquioxane that has a liquid-like moiety, comprising curing the bifunctional polymer in the presence of an initiator. In some embodiments, the initiator is made active by exposing it to heat or light. In an embodiment, the initiator is activated by UV light, visible light, or heat. In an embodiment, the base catalyst is potassium carbonate or ammonia. In an embodiment, the R¹ is perfluorinated poly(propylene oxide) moiety. In an embodiment, the R² comprises epoxide, aryl, heteroaryl, vinyl, aziridine, amino, carboxy, hydroxy, thiol, anhydride, phosphino, silane (SiH) moiety, or a combination thereof. In an embodiment, each R^{sac} is the same. In an embodiment, the R^{sac} of R¹Si(OR^{Sac})₃ is different than the R^{sac} of R²Si(OR^{sac})₃. In an embodiment, each R^{sac} is independently a saturated aliphatic moiety. In an embodiment, the saturated aliphatic moiety is methyl, ethyl, or isopropyl.

In one aspect, the invention provides a polymer of formula 1, where n is 1 to 1000, x is 0 to 1, R¹ comprises a liquid-like moiety, and R² comprises a crosslinkable moiety.

In one aspect, the invention provides a method of making an omniphobic coating, comprising reacting (i) ladder-like polysilsesquioxane (LASQ) with (ii) a compound comprising a liquid like moiety and a functional moiety that reacts with LASQ to provide modified LASQ that bears a grafted liquid-like moiety; or
(i) ladder-like polysilsesquioxane (LASQ) that comprises a functional moiety with (ii) a compound comprising a liquid like moiety and a functional moiety, to provide a mixture that comprises LASQ and a graft copolymer of LASQ that has sidechains bearing liquid like moieties; and curing the mixture.

In an embodiment, the compound comprising a liquid like moiety and a functional moiety is: perfluorinated poly(propylene oxide) bearing a terminal carboxyl group; PDMS bearing a terminal amino group (PDMS-NH₂); C₁₂H₁₅—NH₂; C₆F₁₃—COOH: C₁₂H₁₅—SH; or H₂N-(PDMAEMA-g-PDMS).

In an embodiment, the LASQ that comprises a functional moiety is: LASQ comprising a vinyl, silanol, or epoxide moiety, and the compound comprising a liquid like moiety is: PDMS-Si(CH₃)₂H. In an embodiment, the coating is highly transparent, flexible, wear resistant, hard, or any combination thereof. In an embodiment, the ratio of the monomer of formula R²Si(OR^{sac})₃ to the monomer of formula R¹Si(OR^{Sac})₃ is 1:3.

In one aspect, the invention provides a method for shedding accumulated material, comprising applying the coating precursor of an above aspect to a substrate, curing the applied coating precursor to form a crosslinked coating, wherein accumulated material on the coating readily sheds.

In one aspect, the invention provides a method for providing an antimicrobial coating comprising applying the polymer of claim 1, wherein wherein R¹ is poly(N,N-dimethylamino methacrylate) (PDMAEMA), curing the applied polymer to form a crosslinked coating, and quaternizing R¹ to provide an antimicrobial moiety.

In one aspect, the invention provides a kit comprising uncured coating precursor comprising bifunctional LASQ of formula 1, optionally ladder-like polysilsesquioxane (LASQ), and instructions to cure the mixture. In an embodiment, the kit further comprises initiator. Non-limiting examples of initiators include triarylsulfonium hexafluoroantimoante, 1-hydroxycyclohexyl phenyl ketone, phenylbis(2,4,6-trimethylbenzoyl)-phosphine oxide, 4,4′-azobis(4-cyanovaleric acid) (ACVA), or azobisisobutyronitrile (AIBN). In an embodiment, the instructions are provided in digital form.

### BRIEF DESCRIPTION OF THE DRAWINGS

For a better understanding of the invention and to show more clearly how it may be carried into effect, reference will now be made, by way of example, to the accompanying drawings, wherein:

FIG. 1A shows a reaction pathway from ECTMS to LASQ, which is shown with an exemplary R² group, where THF is tetrahydrofuran.

FIG. 1B shows a reaction pathway from LASQ to a bifunctional LASQ, where TEA, BA, TFT refer to triethyl amine, butyl acetate, and trifluorotoluene, respectively.

FIG. 1C shows a reaction pathway for ECTMS and DTMS (dodecyltrimethoxysilane to form a bifunctional LASQ of the structural formula shown.

FIG. 2A shows SEC traces of refractive index vs. retention time of samples taken from an 2-(3,4-epoxycyclohexyl)ethyltrimethoxysilane (ECTMS) reaction mixture at 9.5, 26, 50, and 72 h.

FIG. 2B shows a comparison of SEC traces of refractive index vs. retention time for fractions 1, 2, 3, and 4 as well as LASQ before fractionation.

FIG. 3A shows ATR FTIR spectra of 20-μm-thick LASQ film photocured for 0, 5, 10, 20, and 30 min, respectively.

FIG. 3B graphically shows a change in epoxide conversion and nanoindentation hardness H of cured 20-μm-thick LASQ films as a function of photolysis time; each epoxide conversion is an average of three measurements and each H datum is an average of more than five measurements, performed at different locations on a sample.

FIG. 4A shows a SEC trace of LASQ (top trace), LASQ-g-FP-2.7 (middle trace) and LASQ-g-FP-6.0 (bottom).

FIG. 4B shows a 1H NMR spectra of LASQ (top trace) and LASQ-FP6.0 (bottom trace).

FIG. 4C shows a 19F NMR spectrum of LASQ-g-FP-6.0 with 4,4′-difluorobenzophenone present as an external standard.

FIG. 4D shows UV-visible transmittance curves recorded for 20-μm-thick cured LASQ, LASQ-g-FP-2.7, and LASQ-g-FP-6.0 coatings on glass slides using the latter as a reference.

FIG. 5 shows shrinking patterns of ink on a 10-μm-thick LASQ-g-FP-6.0 coating on a 50-μm-thick PET film before (left) and after (right) being subjected to outward bending to a diameter of 4 mm 200 times.

FIG. 6A shows a comparison of ink contraction behavior of 40-μm-thick LASQ-g-FP-2.7 and LASQ-g-FP-6.0 coatings on glass slides, and a LASQ-g-FP-6.0 coating on a 150-μm-thick PET film after being abraded with steel wool for various strokes.

FIG. 6B shows a comparison of ink contraction behavior of LASQ-g-FP-6.0 coatings of specified thicknesses on glass slides after being abraded with steel wool for various strokes.

FIG. 7A shows a plot of ice adhesion strength vs. icing/deicing cycles for specified samples of LASQ-PDMS₅ₖ-8.7.

FIG. 7B shows a plot of ice adhesion strength vs. icing/deicing cycles for specified samples of LASQ-PDMS₁₀ₖ-6.0.

FIG. 8A shows SEC traces of refractive index vs. retention time of aliquots of a LASQ and DTMS copolymerization reaction that occurred in the presence of SDS surfactant; the trace with the lower refractive index maximum was an aliquot taken at 24 hour reaction time, the trace with the higher refractive index maximum was an aliquot taken at 6 hour reaction time.

FIG. 8B shows SEC traces of refractive index vs. retention time of aliquots of a copolymerization of ECTMS and DTMS that occurred in the absence of SDS surfactant; Sample 1 is an aliquot that was obtained 24 hours after the reaction began. Sample 2 is an aliquot that was obtained 48 hours after the reaction began. The peaks in samples 1 and 2 at 31 minutes show the presence of unreacted monomer. The polymer began to form as seen in sample 3, which is an aliquot that was obtained 72 hours after the reaction began. Sample 4 indicates that the copolymer is formed; this aliquot was obtained 120 hours after the reaction began.

FIG. 8C shows SEC traces of aliquots of a copolymerization reaction of LASQ and an 8:1 ratio of ECTMS (provides hardness) and DTMS (lower surface energy).

### DETAILED DESCRIPTION OF EMBODIMENTS

As used herein, “LASQ” refers to ladder-like polysilsesquioxane.

As used herein, “PDMS” refers to polydimethylsiloxane.

As used herein the term “LASQ-PDMSₓ-y” refers to a ladder-like polysilsesquioxane (LASQ) that bears a liquid-like moiety that is PDMS, where x denotes molar mass of polydimethylsiloxane (PDMS) and y denotes mass fraction of the grafted PDMS.

As used herein, “PDMAEMA” refers to poly(N,N-dimethylamino methacrylate).

As used herein, “PDMAEMA-g-PDMS” refers to a PDMAEMA backbone bearing a graft PDMS side chain.

As used herein, “LASQ-g-(PDMAEMA-g-PDMS)” refers to graft copolymer that has a LASQ backbone bearing a PDMAEMA-g-PDMS graft copolymer side chain.

As used herein “LASQ-g-(QPDMAEMA-g-PDMS)” refers to an LASQ with grafted quaternized N,N-dimethylaminoethyl methacrylate moiteies.

As used herein, “NH₂-(PDMAEMA-g-PDMS) refers to an amino-terminated poly(N,N-dimethylamino methacrylate) backbone with grafted PDMS sidechains.

As used herein, “COOH-(PDMAEMA-g-PDMS)” refers to a carboxylic-terminated poly(N,N-dimethylamino methacrylate) backbone with grafted PDMS sidechains.

Previously, providing a hard yet flexible, anti-smudge protective layer on a touchscreen was only possible using a method that included a series of separate deposition steps. A bilayer bifunctional coating is described herein that was produced from deposition of a single polymer. As used herein, the term “LASQ” refers to a ladder-like polysilsesquioxane derived from the sol-gel chemistry of 2-(3,4-epoxycyclohexyl)ethyltrimethoxysilane (ECTMS). Cured ECTMS-derived LASQ exhibited rollability and exceptional hardness.

The bilayer bifunctional coating is prepared from a graft copolymer of ladder-like polysilsesquioxane (LASQ) wherein there are two different types of side chains; one type of side chain bears a liquid-like moiety while the other type of side chain bears a moiety that enables curing (i.e., crosslinking) of the copolymer.

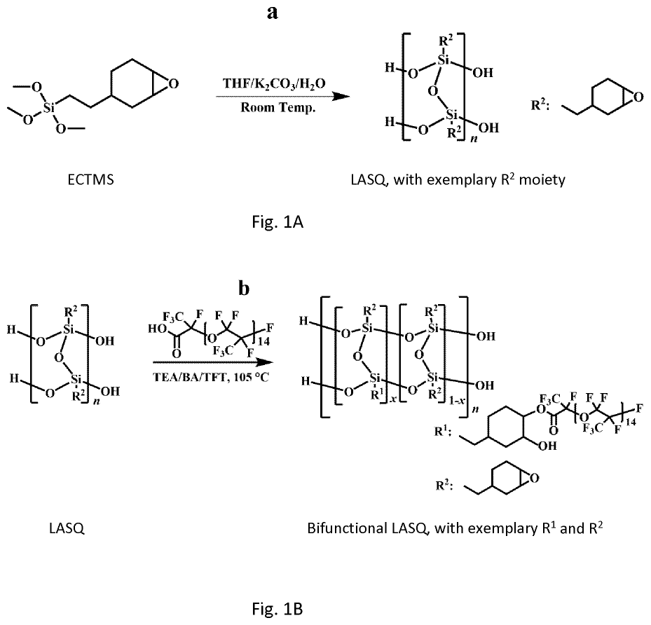

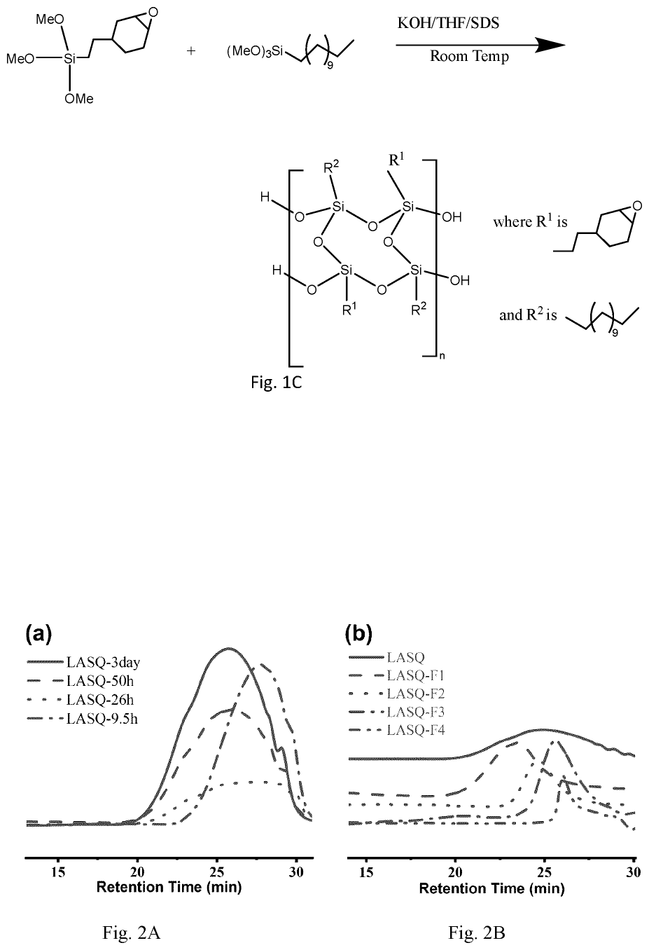

The term “LASQ-bf” refers to a bifunctional LASQ. An example of an LASQ-bf is a graft copolymer bearing two types of side chains that are functional moieties. Some side chains include liquid-like moieties (e.g., perfluorinated poly(propylene oxide). Some other side chains include moieties that enable crosslinking (e.g., epoxides). See FIGS. 1A and 1B for structural formulae.

A liquid-like component refers to any moiety with a Tg below room temp, examples include a C₆ to C₁₇ alkyl moiety, PDMS, perfluoroinated polyether, polyisobutylene, or a combination thereof. Liquid-like refers to a moiety that is a liquid (i.e., not a wax) at room temperature but that is covalently-attached to LASQ, which may be cured. In one embodiment, a polymer is described that can be deposited in a single step to yield a coating that serves the dual function of an anti-smudge layer and a bendable protective layer with glass-like hardness and polymer-like flexibility. This protective anti-smudge coating is suitable for bendable or foldable smartphones. This material has many other applications as well. In particular, any surface that would benefit from preventing dirt or fingerprints from sticking to it. This may include frequently touched surfaces such as elevator buttons or payment machine buttons, bank machines, bathroom surfaces such as shower walls and doors, any article that has a screen (e.g., smartphone, tablet, monitor, television, display screen), windshield, musical instrument, medical instrument, tools, solar cell, automotive body, doors, bus shelters, public transportation vehicles or stations, metal doors, household appliances, eyeglasses, drinking glasses, lenses, scientific and medical instruments, furniture, dining tables, chairs, sofas, power line, surveillance equipment, surveillance camera, blades of a wind turbine, solar cell panels, or wings of an airplane.

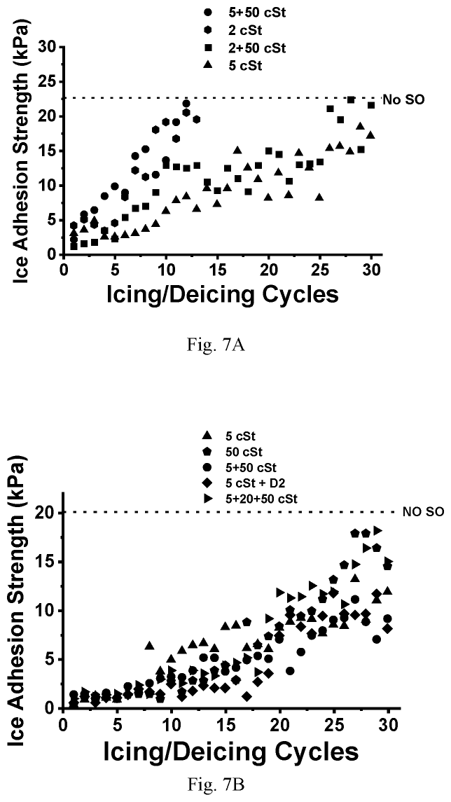

In one embodiment, the omniphobic coating is used for its ice-shedding properties. After application of cured LASQ bearing a liquid like moiety on glass, ice adhesion strength was reduced by 40 times. In one embodiment, a method of shedding accumulated material is described. As shown in FIGS. 7A and 7B, plots are shown that demonstrate long term performance of lubricated LASQ-PDMS. The LASQ-PDMS coatings are lubricated with SO of viscosity levels 2, 5, 20, and 50 cSt, or combinations thereof. The shedding ability of the lubricated coatings was quantified by ice adhesion strength tests. Details of the ice adhesion tests are described in Example 7 and shown in FIGS. 7A and 7B. SO-lubricated LASQ-PDMS₁₀ₖ-6.0 coatings exhibited long-term ice-shedding performance. This result is quantified as shown in FIGS. 7A and 7B, by a ice adhesion strength value that is lower, which indicates more ability to shed ice.

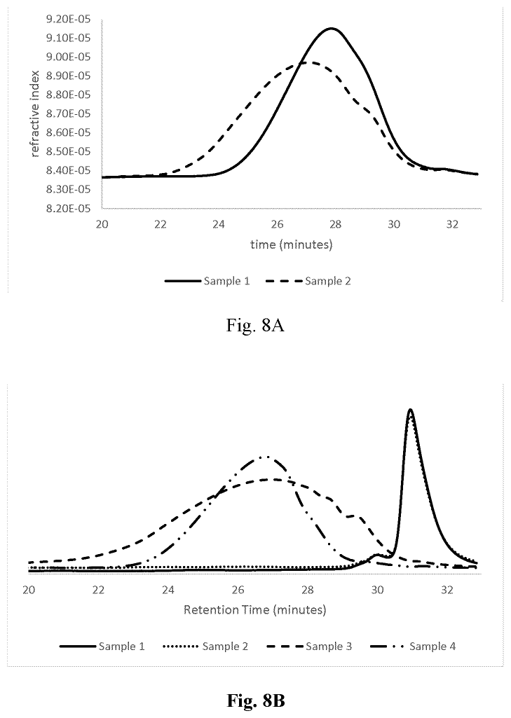

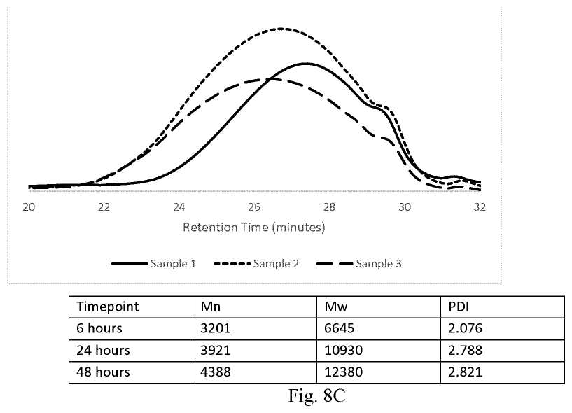

FIG. 8A displays SEC traces from copolymerization of ECTMS and DTMS where SDS surfactant is included in the reaction. Sample 1 was an aliquot that was obtained 6 hours after the reaction began Sample 2 was an aliquot that was obtained 24 hours after the reaction began. The presence of surfactant increased the solubility of DTMS monomer and increased the rate of polymerization. For comparison, FIG. 8B shows the reactions in the absence of surfactant.

FIG. 8B shows SEC traces of aliquots of a copolymerization of ECTMS and DTMS where SDS is absent. Sample 1 from 24 hours after the reaction began, and sample 2 (48 h) have a peak at 31 minutes which is unreacted monomer. There is evidence that the polymer began to form in sample 3 (72 h). Sample 4 (120 h) indicates that the copolymer is formed.

FIG. 8C shows SEC traces of aliquots of a copolymerization of ECTMS and DTMS that were present in a 8:1 molar ratio, and SDS was present in the reaction. Sample 1 is from 6 hours after the reaction began. Sample 2 is from 24 hour after the reaction began. Sample 3 is from 48 hours after the reaction began. The molecular weight of the polymer increased as the reaction progressed and as the copolymer was formed. In one embodiment, a coating is provided that is antismudge and anti-bacteria at the same time. After the curing of LASQ-g-(PqPDMAEMA-g-PDMS), which denotes a double graft copolymer consisting of a LASQ backbone bearing side chains consisting of quaternized (q) PDMAEMA bearing PDMS grafts, this coating is anti-smudge under normal conditions because PDMS resides on the surface of the coating. However, the hydrophilic qDMAEMA groups rise to the surface and kill bacteria.

As described in the Working Examples and shown in the figures and tables, this bilayer bifunctional coating has a facile preparation. Methods of making an uncured bilayer bifunctional coating precursor mixture and of making the cured omniphobic coating are described herein. The base polymer of the coating is LASQ where the bifunctional feature is provided by the presence of a liquid like moiety, and a crosslinkable moiety. In one embodiment, all of the coating precursor is bifunctional LASQ (“LASQ-bf”) and thus has the two functional moieties. In one embodiment, a part of the precursor coating is LASQ-bf, and another portion of the coating precursor is LASQ. LASQ does not bear a liquid-like moiety, but bears a crosslinkable moiety. Accordingly, the term m-LASQ-LASQ-bf refers to a mixture (m) of LASQ and bifunctional LASQ (LASQ-bf). m-LASQ-LASQ-bf (rather that a physical mixture of LASQ and FP-COOH, where FP refers to perfluorinated poly(propylene oxide), was used to prepare the coating to avoid macrophase separation of LASQ and FP-COOH during film formation and to ensure a high transparency of the resultant coating.

This coating, once cured, has a hardness value (H) of, for example, 1.4 GPa. This hardness value is in excess of 8 times higher than the H value of poly(ethylene terephthalate) (PET). At a thickness of 40 μm on a glass slide, an embodiment of the bilayer bifunctional coating that had 6.0 wt % of fluorine was shown to be highly transparent with a transmittance of >99% at 500 nm when this value was measured using the glass slide as the reference. This bilayer bifunctional coating was omniphobic with a low surface energy of 12.3±1.5 mJ/m². Notably, this coating on a PET substrate underwent inward bending on the inner side of a bend to radii <1 mm without cracking.

In some embodiments, the polymer used to prepare the coatings is m-LASQ-LASQ-bf, a mixture of a ladder-like polysilsesquioxane (LASQ) and LASQ-bf (see FIGS. 1A and 1B)). LASQ was prepared from sol-gel chemistry of 2-(3,4-epoxycyclohexyl)ethyltrimethoxysilane (ECTMS). In one embodiment, m-LASQ-LASQ-bf is prepared by reacting LASQ with a limiting amount of a liquid like anti-smudge agent bearing a terminal carboxyl group (e.g., perfluorinated poly(propylene oxide) (FP) bearing a terminal carboxyl group (FP-COOH)).

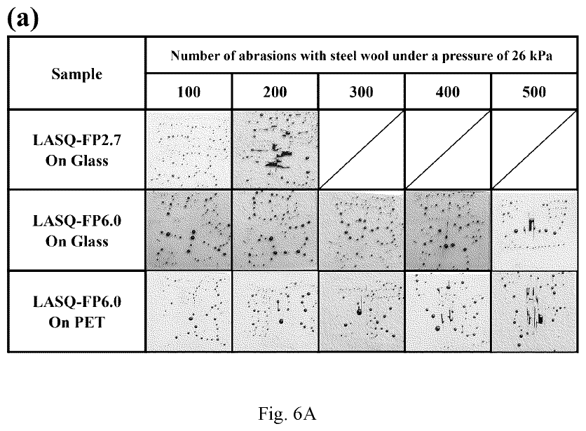

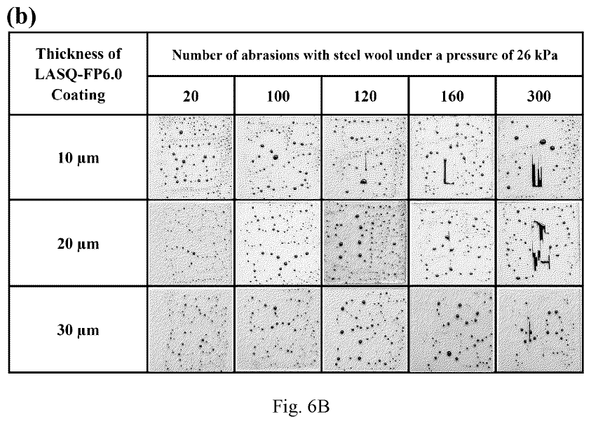

An embodiment of an m-LASQ-LASQ-bf having a F mass fraction of 6.0% was photocured to yield a coating with a surface energy of 12.3±1.5 mJ/m². On a glass slide at a thickness of 20 μm, the coating has a transmission of >99% at 500 nm, a remarkable nanoindentation hardness H of 1.4 GPa, and a pencil hardness >9H. After being abraded for 300 times under a pressure of 26 kPa with steel wool, the coating exhibited no noticeable degradation in its ink contraction properties (see FIG. 5-6B). At a thickness of 10 μm on a poly(ethylene terephthalate) film, this coating underwent inward (on the inner surface of the bend) and outward (on the outer surface of the bend) bending without cracking to radii <1 mm and <2 mm, respectively.

In one embodiment, FP rather than the less expensive and environmentally more benign poly(dimethyl siloxane) was used as the anti-smudge agent because fingerprint precursors are complex slurries of water, salts, proteins, as well as fatty acids and esters, and the FP layer with a free energy lower than that offered by PDMS is more effective in fingerprint inhibition.

Dynamic dewetting properties of a liquid-like surface monolayer that had been directly grafted on a substrate has been reported. However, the grafting of a liquid-like monolayer directly onto a flexible polyimide or PET film does not significantly improve the wear resistance of the polymer substrate and does not offer the desired wear protection.

To prepare a coating that is transparent, has high hardness, and has wear resistance, a m-LASQ-LASQ-bf/photoinitiator solution was cast on a substrate. The low surface tension of the liquid like moiety causes that moiety to migrate to the surface during solvent evaporation and causes the eventual formation of a tethered liquid like monolayer on the coating's surface. Additionally, liquid like moieties segregates from LASQ in the coating's matrix to form nanopools of a grafted lubricating ingredient for dewetting enablement (NP-GLIDE) (see Gee, E., et al., Langmuir 2018, 34, 10102-13; Hu, H., et al., J. Mater. Chem. A. 2019, 7, 1519-28; Huang, S. S., et al., Chem. Eng. J. 2018, 351, 210-20). The cast film is photocured due to cationic ring-opening polymerization of pendant epoxycyclohexyl groups.

LASQ has been synthesized from ECTMS and fractionated to yield samples of different molecular weights. A systematic study suggested that the H value of cured LASQ increases with LASQ molecular weight initially when its PS-equivalent M_{w} is below ˜ 10 kDa but changes little with the latter for sample with M_{w}>˜14 kDa. The reaction of LASQ with a limiting amount of FP-COOH under optimised conditions produced a mixture of LASQ and LASP-FP and unreacted FP-COOH was readily separated by centrifugal precipitation. Casting a solution containing a mixture of LASQ and LASP-FP on a substrate and solvent evaporation spontaneously yielded a bilayer coating consisting of a surface FP monolayer and LASQ matrix containing embedded FP nanopools. The m-LASP-FP coatings were discovered to photocure faster and more completely than LASQ. At bulk fluorine mass fractions of 2.7% or 6.0%, the cured m-LASP-FP coatings feature the low surface energies of 13.4±1.2 and 12.3±1.5 mJ/m². On these coatings, water and oils readily contract and cleanly slide without leaving behind any traces. The cured LASP-FP6.0 coating at a thickness of 20 μm has a transmission of >99% at 500 nm, a remarkable nano-indentation hardness H of 1.4 GPa, and a pencil hardness >9H. After being subjected to a very harsh wearing test involving abrasion with steel wool for 300 times under a pressure of 26 kPa, the coating exhibits no noticeable degradation in its ink contraction properties. At a thickness of 10 μm on a poly(ethylene terephthalate) film, the coating can undergo inward and outward bending without cracking to radii <1 mm and <2 mm, respectively. Such highly wear resistant, transparent, anti-smudge, flexible, facilely-fabricated bilayer coating will be an alternative for currently-used protective and anti-fingerprint layers for touchscreens of foldable displays. These bilayer coatings should also find many other applications, e.g., as coatings for security cameras, appliances, elevator doors, and musical instruments, windturbines, solar cells. Such coatings may be used to promote ice shedding on many objects include, but not limited to, airplanes, windshields of all types of transportation, for solar cells, and windturbines.

Referring to FIGS. 1A and 1B, it is possible to co-condense or co-polymerize two types of monomers to make a bi-functional LASQ (LASQ-bf) or a co-LASQ. R^{sac} refers to a sacrificial moiety that is present in a reactant but that is not present in the product. Examples of typical sacrificial groups include a saturated aliphatic moiety (e.g., methyl, ethyl, isopropyl). Functional monomers used to make LASQ-bf have the general formulas R¹Si(OR^{sac})₃, and R²Si(OR^{sac})₃ where R^{sac} is a sacrificial group that can be any saturate aliphatic group (e.g., methyl, ethyl), R¹ includes a liquid like functional moiety that confers anti-smudge properties, and R² includes a functional moiety that enables the product polymer to be crosslinked (e.g., epoxide, double bond, amine, aziridine). Examples of monomers bearing crosslinkable moieties include 2-(3,4-epoxycyclohexyl)ethyltrimethoxysilane, (3-glycidyloxypropyl) trimethoxysilane, (3-methacryloxypropyl) trimethoxysilane, (3-acryloxypropyl) trimethoxysilane, or (3-aminopropyl) trimethoxysilane. Examples of monomers bearing liquid-like moieties include decyltrimethoxysilane, dodecyltrimethoxysilane, tridecafluoro hexyltrimethoxysilane, PDMS bearin a terminal trimethoxysilane group, PDMS bearing a terminal triethoxysilane group, PFPE bearing a terminal trialkoxysilane group.

In one embodiment, (3-glycidyloxypropyl) trimethoxysilane and (3-methacryloxypropyl) trimethoxysilane monomers were copolymerized to prepare LASQ-bf bearing both glycidyl and methacrylate functionalities. The molar ratio between the two types of monomers was adjusted. In some embodiments, the ratio of the monomer of formula R²Si(OR^{sac})₃ to the monomer of formula R¹Si(OR^{Sac})₃ is 1:3. was used, where R¹ is a group comprising a liquid like moiety and R² is a group comprising a crosslinking functional moiety.

In one embodiment, the bifunctional LASQ shown in FIG. 1C was synthesized, as described in Example 8.

A mixture of an epoxide-bearing coupling agent (i.e., monomer), a coupling agent or monomer bearing a liquid-like moiety, and a non-functional coupling agent (e.g., phenyl- or butyl-bearing agent) can be copolymerized to yield a LASQ-bf. This non-functional monomer is used to adjust the physical properties (e.g., rigidity and flexibility and crosslinking density) of the final cured LASQ-bf coating. As well, epoxide-bearing and (meth)acrylate-bearing coupling agents can be copolymerized together to yield a LASQ that can be crosslinked via different mechanisms including free radical polymerization, cationic ring-opening polymerization, or a combination of the two. Also, cyclohexyl epoxy was combined with 3-glycidyloxypropyl groups to make a crosslinkable LASQ with different properties than a LASQ that had been crosslinked by only one type of epoxide.

Non-functional coupling agents such as isobutyltrimethoxysilane, n-propyltrimethoxysilane, hexyltrimethoxysilane, cyclohexyltrimethoxysilane, phenyltrimethoxysilane can be used.

Examples of monomers that include a liquid like moiety (i.e., anti-smudge) include PDMS or perfluorinated polyether (PFPE) bearing a terminal trimethoxysilane or triethoxysilane group, (1H,1H,2H,2H-perfluorodecyl)trimethoxysilane, and (1H,1H,2H,2H-perfluorooctyl)trimethoxysilane. In one embodiment, monomer (1H,1H,2H,2H-perfluorodecyl)trimethoxysilane was co-hydrolyzed and co-condensed with the crosslinkable monomer (i.e., coupling agent) 3-glycidyloxypropyl) trimethoxysilane in a one-step reaction.

In one embodiment, anti-smudge monomer (1H,1H,2H,2H-perfluorooctyl)trimethoxysilane was co-hydrolyzed and co-condensed with the crosslinkable monomer (e.g., 3-glycidyloxypropyl) trimethoxysilane) in a one-step reaction.

In one embodiment, (2-(3 4-epoxycyclohexyl)ethyl trimethoxysilane) (ECTMS) was co-condensed with monotriethoxysilylethyl terminated polydimethylsiloxane (PDMS-TEOS) by hydrolyzing PDMS-TEOS with HCl, followed by neutralizing with NaOH, then ECTMS was added into it in the system of THF/K₂CO₃/H₂O.

### WORKING EXAMPLES

The following working examples further illustrate the invention and are not intended to be limiting in any respect. As used herein, “SO” is silicone oil. As used herein, “cSt” is centistoke, which is a unit of viscosity. Silicone oils (2 cSt and 5 cSt) were purchased from Gelest (Morrisville, PA, USA) and used as received. Silicone oils (20 and 50 cSt) were purchased from Sigma-Aldrich (Oakville, Canada). Fluorosil D2, referred to herein as “D2”, refers to fluorinated silicone oil (available from Siltech, Canada of Toronto, Canada). G10/FR4 Epoxy glass sheets (0.032″×1″×1″) were purchased from ePlastics (Coppell, TX, USA).

Size exclusion chromatography (SEC) analyses were performed on an Agilent instrument equipped with a Wyatt Optilab T-rEX refractive index (RI) detector. Tetrahydrofuran was used as the eluent at a flow rate of 1.00 mL/min. Columns (MZ-Gel SDplus) were packed with beads possessing nominal pore sizes of 500, 10000 and 100000 Å, respectively. The SEC system was calibrated with narrowly dispersed polystyrene standards.

### Example 1. LASQ Synthesis, Fractionation, and Characterization

Materials. Tetrahydrofuran (THF) was freshly distilled from sodium/benzophenone prior to use. 2-(Dimethylamino)ethyl methacrylate (DMAEMA) was distilled under reduced pressure, and monomethacryloxypropyl terminated polydimethylsiloxane (PDMS-MA, 800-1000 g/mol) was passed through basic alumina before use. Azobisisobutyronitrile (AIBN) was recrystallized from methanol prior to use. All other solvents and reagents employed in this investigation were reagent grade and were used as supplied without further purification.

### Example 1A. LASQ Synthesis and Characterization

LASQ was prepared following a literature method (Lee, A. S., et al., RSC Adv. 2014, 4, 56532-38). ECTMS (43.0 g, 1.75×10⁻¹ mol) was added dropwise under nitrogen into a clear mixture of water (9.70 mL, 5.39×10⁻¹ mol), THF (12.9 mL) and potassium carbonate (89.8 mg, 6.50×10⁻⁴ mol) (see FIGS. 1A and 1B). After the mixture was stirred for 3 d, volatile components were removed under reduced pressure via rotary-evaporation. The solid residue was re-dissolved in 300-mL dichloromethane and the non-aqueous layer was extracted with water until its pH became neutral. The non-aqueous layer was then dried over MgSO₄ and filtered. Evaporation of the solvent under reduced pressure via rota-evaporation yielded 29.9 g of LASQ as a semi-translucent sticky solid at a yield of 96%. It was redissolved in butyl acetate (50.0 wt %) for storage.

FIG. 2A shows SEC traces of crude product varied with reaction time. The peak position shifts initially to higher molecular weights with reaction time. However, the peak position and shape of the 50-h and 72-h samples were similar. Thus, subsequent samples were prepared using a reaction time of 3 d. An SEC analysis of one such sample yielded a polystyrene-equivalent weight-average molecular weight M_{w} of 2.0×10⁴ Da and a dispersity index M_{w}/Mₙ of 3.54 (see Table 1).

Choi et al. established that the polysilsesquioxanes thus synthesized possess mostly a ladder-like structure; the ¹H and ²⁹Si NMR spectra of synthesized samples agreed with those reported by Choi et al. (see Choi, G. M., et al., Adv. Mater. 2017, 29, 1700205-12, Lee, A. S., et al., RSC Adv. 2014, 4, 56532-38). That is, the T³ (R—Si(OSi—)₃) peak was predominant between −65 and −75 ppm and the T² (R—Si(OSi—)₂OH) peak was not noticed between −58 and −60 ppm in the ²⁹Si NMR spectrum. This result suggested a low concentration of terminal silanol groups which was in agreement with the high M_{w} value determined by SEC for this sample.

### Example 1B. Synthesis of LASQ-FP2.7 and LASQ-FP6.0

To prepare LASQ-FP6.0, LASQ-FP containing 6.0 wt % fluorine, LASQ (7.60 g containing 43.0 mmol of epoxy), FP-COOH (1.17 g or 0.47 mmol), and triethylamine (6.0 mL or 43.0 mmol) were stirred and heated at 105° C. overnight in 45 mL of trifluorotoluene and 16 mL of butyl acetate. The mixture was cooled down and centrifuged at 8500 rpm (9710 g) for 10 min to remove unreacted FP-COOH and insoluble side products. The supernatant was concentrated via rota-evaporation and the concentrate was added into excess hexanes to precipitate the polymer. After supernatant removal via decantation, the solid product was dried in a 60° C. vacuum oven for 30 min to yield a pale orange sticky solid (7.69 g, 87.7% yield). The product was redissolved and stored in butyl acetate as a 50 wt % solution.

To prepare LASQ-FP2.7, LASQ-FP containing 2.7 wt % fluorine, a similar procedure was used. Instead of using a feed fluorine mass fraction of 9.1% as in the synthesis of LASQ-FP6.0, a feed fluorine mass fraction of 4.8% was used in this case.

### Example 1C. LASQ Fractionation

To obtain LASQ fractions of different molecular weights, LASQ was dissolved in acetone. Acetonitrile was added into the solution to form a cloudy mixture. The mixture was left standing in a fridge at −4° C. overnight to allow separation of a polymer-rich layer from supernatant. After separation of a bottom layer, a procedure involving acetonitrile addition, phase separation, and bottom layer removal was repeated to get more fractions.

To investigate the effect of varying the molecular weight of LASQ on its mechanical properties, a sample was fractionated via fractional precipitation, to yield samples of different molecular weights. SEC traces of the different fractions (F) 1-4 are shown in FIG. 2B. M_{w} and M_{w}/Mₙ values are listed in Table 1.

### Example 1D. Casting

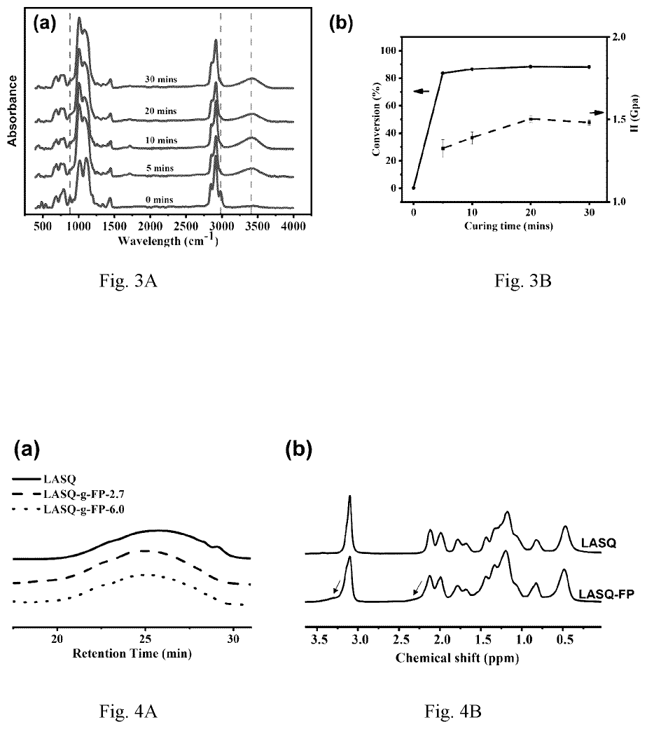

Casting a LASQ solution containing 1.25 wt % of photoinitiator triarylsulfonium hexafluoroantimoante on a glass slide or PET substrate and waiting for solvent evaporation yielded a LASQ film. The film thickness was regulated by controlling the mass of LASQ cast per unit substrate area. Photolysis of the solid film cured LASQ yielding a coating. FIG. 3A compares ATR-FTIR spectra of 20-μm-thick LASQ films photolyzed for 0 to 5, 10, 20, and 30 min. Upon photolysis, a 885 cm⁻¹ peak characteristic of C—O—C stretch of an epoxide ring and a 2989 cm⁻¹ peak characteristic of C—H stretching of an epoxide CH₂ group decreased in intensity. At the same time, a 3413 cm⁻¹ peak for OH stretching increased in intensity. FIG. 3B shows how the intensity of a 885 cm⁻¹ peak decreased as a function of time. By 5 min, the intensity decreased by 84±2%. Beyond this time, the epoxide conversion did not increase much. The incomplete conversion of the epoxide groups during LASQ photocuring was attributed to the limited mobility of the cationic centers in a highly crosslinked LASQ matrix.

To fabricate a 40-μm-thick omniphobic coating, m-LASQ-LASQ-bf (64 mg of a butyl acetate solution or 32 mg of the polymer mixture) and mixed salts of triarylsulfonium hexafluoroantimoante (TSHFA, 0.57 μL of their 50 wt % solution in propylene carbonate) were added into 0.30 mL of di(propylene glycol) methyl ether. The mixture was then cast onto a glass slide (1×1 inch²) and solvent was allowed to evaporate overnight at 60° C. under gentle nitrogen flow. The sample was then photolyzed for 20 min with a focused beam from a 500-W mercury lamp that passed through a 280 nm cut-off filter. To prepare a coating on a PET film, the PET film was first treated for 15 s with an oxygen plasma, which was generated at an oxygen flow rate 4.0 standard cubic centimetres per min and a power output of 50 W using Tergeo plasma cleaner (Pie Scientific LLC). The subsequent procedure was the same as that used to coat a glass plate. Coatings of other thicknesses were obtained by adjusting the mass of LASQ-FP used per unit coating area. In calculating the thicknesses of the coatings, the density of 1.25 g/cm³ for ECTMS was used to approximate that of LASQ-FP.

### Example 1E. Polymerization Study

For kinetic study for the polymerization of ECTMS to yield LASQ, samples were drawn through a syringe under nitrogen protection after 9.5 h, 26 h, 50 h, and 3 days. To stop the polymerization after a sample was taken, the sample was dried via rota-evaporation before dichloromethane was added and the non-aqueous phase extracted with water to remove K₂CO₃. After the dichlooromethane layer was dried with MgSO₄ and filtered, SEC analyses of the samples were conducted immediately (see FIGS. 5-6B).

Various conditions were explored for the opening of the epoxy ring of LASQ by FP-COOH to produce LASQ-FP (see FIG. 1B). The reaction was performed at 105° C. in trifluorotoluene/butyl acetate at v/v=45/16 using 1 molar equivalent of triethylamine relative to the epoxide units as the catalyst. A trifluorotoluene/butyl acetate mixture was used as the reaction medium because trifluorotoluene (or other fluorinated solvents, such as methoxyperfluorobutane) alone could not dissolve LASQ but could dissolve FP-COOH, and butyl acetate alone did not dissolve FP-COOH, but could dissolve LASQ. Triethylamine was chosen as a catalyst because tetrabutylammonium bromide (TBAB) caused degradation of LASQ. 4-dimethylaminopyridine was not as efficient a catalyst and could not be as facilely removed from the reacted mixture as triethylamine could. A reaction temperature of 105° C. was identified because the extent of reaction was low when 70° C. was used. It was undesirable to use a reaction temperature that was higher than the boiling point of trifluorotoluene. A reaction time longer than overnight was not used because the yellow color of the reacting mixture deepened as the reaction time increased. The yellowing was considered to be due to the oxidation of trimethylamine.

Two m-LASQ-LASQ-bf samples, LASQ-g-FP-6.0 and LASQ-g-FP-2.7, were prepared using the afore-mentioned conditions. At an F mass fraction of 6.0% and using a PS-equivalent number-average molecular weight of 5.7×10³ Da for LASQ, LASQ-g-FP-6.0 was calculated to consist of 79% of LASQ chains and 21% of LASQ-FP chains. As for LASQ-g-FP-2.7, these numbers are 91% and 9%, respectively. The successful grafting of FP-COOH to LASQ could be judged from the optical clarity of films of m-LASQ-LASQ-bf because nongrafted FP-COOH phase-separates from LASQ resulting in a cloudy film.

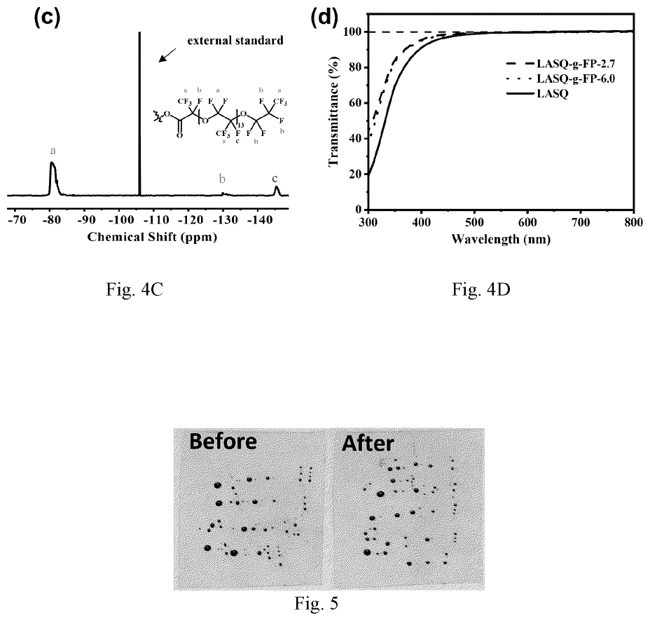

SEC and ¹H NMR were used to show that LASQ-g-FP-2.7 and LASQ-g-FP-6.0 were prepared without significant side reactions. FIG. 4A shows that SEC traces of LASQ, LASQ-g-FP-2.7, LASQ-g-FP-6.0 samples are very similar aside from the anticipated shifts of m-LASQ-LASQ-bf peaks to a higher molecular weight side relative to the LASQ peak. In FIG. 4B, ¹H NMR spectra are compared for LASQ and LASQ-g-FP-6.0. The peaks are essentially identical for the two samples aside from the appearance of tiny shoulders to the left of some LASQ peaks. These shoulders arise due to the shift of some proton peaks for the cyclohexyl groups after the opening of the epoxide ring.

The mass fractions of F in LASQ-g-FP6.0 and LASQ-g-FP2.7 were quantified via 19F NMR. FIG. 4C shows a ¹⁹F NMR spectrum and peak assignments for LASQ-g-FP-6.0. The added external standard was 4,4′-difluorobenzophenone.

### Example 1F. a Subset of m-LASQ-LASQ-Bf Coating that are LASQ-g-FP Coatings, Preparation and Structure

LASQ-g-FP-6.0 and LASQ-g-FP-2.7 coatings were prepared analogously as the LASQ coatings. ATR-FTIR spectra for 20-μm-thick LASQ-FP6.0 coating samples cured for 0, 5, 10, 15, 20, and 30 min were obtained. The ATR-FTIR data show that the intensity of the 885 cm⁻¹ peak characteristic of the C—O—C stretch of the epoxide ring decreased by more than 90% after 5 min of photolysis and eventually reached 96±1% by 30 min. Thus, the epoxide groups in the LASQ-g-FP-6.0 sample reacted faster and more completely than those in the LASQ sample. Although not wishing to be bound by theory, the inventors suggest that this may be due to the plasticizing effect of the FP chains in the LASQ matrix. The faster curing of the epoxide rings in the m-LASQ-LASQ-bf coating is also reflected in the plateauing of the H value of this sample within 10 min rather than 20 min for the LASQ sample after photolysis (see FIG. 3B).

The cured LASQ-FP coatings were highly transparent. FIG. 4D compares UV-visible transmittance spectra of 20-μm-thick LASQ, LASQ-g-FP-2.7, and LASQ-g-FP-6.0 coatings on glass slides. All these samples have over 99% transmittance above 500 nm when glass slides were used as the reference in transmittance measurement. A surprising observation is that the cured m-LASQ-LASQ-bf samples have higher transmittances in the UV region than the base LASQ coating. This difference may be due to more efficient decomposition of the light-absorbing photoinitiator in the m-LASQ-LASQ-bf than in the LASQ coating, which agrees with a higher extent of epoxide conversion in the m-LASQ-LASQ-bf than in the LASQ coating.

The high transmittance of these m-LASQ-LASQ-bf coatings should be due to formation of FP domains with diameters that are much smaller than the wavelength of light inside the LASQ matrix and the insignificant scattering of light from the interfaces between LASQ and FP nanopools. LASQ and FP are highly incompatible but are tethered together.

### Example 1G. Abrasion Tests of m-LASQ-LASQ-bf Coatings

Ink contraction behavior of 50-μm-thick GPOSS-PDMS and 40-μm-thick LASQ-g-FP-6.0 coating on glass were compared after they had been abraded by steel wool under 13 kPa for various numbers of strokes. Both coatings had superb ink contraction properties due to their surface PDMS and FP layers, respectively. However, a long non-ink-shrinking streak and one rectangular ink puddle were seen on the GPOSS/GPOSS-PDMS coating after it was abraded 60 times. Only a sharp short non-ink-shrinking line was noticed on the LASQ-FP6.0 coating after 500 abrasions. Since the loss of ink contraction ability should be due to removal of the surface liquid like (e.g., PDMS or FP) layer, these results suggest that the LASQ-FP6.0 coating is much more wear resistant than the previously reported GPOSS-PDMS coating.

To reduce the number of abrading strokes required to degrade ink contraction properties, 40-μm-thick LASQ-g-FP-2.7 and LASQ-g-FP-6.0 coatings on glass slides were subsequently abraded with steel wool under a pressure 26 kPa and compared. FIG. 6A showed that 200 abrasions caused significant deterioration in the ink contraction ability of the LASQ-g-FP-2.7 coating. In contrast, minimal damage was noticed of the LASQ-g-FP-6.0 coating even after 400 abrasions. Thus, increasing the F content from 2.7% to 6.0% increased the wear resistance of the m-LASQ-LASQ-bf coating. This result agrees with a higher concentration of FP on the LASQ-g-FP-6.0 coating than on the LASQ-g-FP-2.7 coating. A longer wearing time is required to remove FP from a more dense FP layer compared to a less dense FP layer.

FIG. 6A further shows that the replacement of a glass slide by a 125-μm-thick PET film as the substrate decreases the wear resistance of the LASQ-g-FP-6.0 coating somewhat. Nonetheless, the LASQ-g-FP-6.0 coating could still survive 200 abrasions with minimal surface damage.

FIG. 6B compares the ink contraction behavior of LASQ-FP6.0 coating samples of the thickness of 10, 20, and 30 μm on glass after different abrasion strokes. The abrasion resistance decreases as the coating thickness decreases. While this trend agrees with the decreasing pencil hardness of the coating samples, we emphasize that the 10-μm-thick coating still survives >100 abrasions by steel wool without noticeable damage.

The ink contraction test was more sensitive than visual or SEM inspection of surface damages. For surface damages to be detectable by the eye, the width and depth of the wearing streaks should on the scale of micrometers. For our environmental SEM, these dimensions should be on the scale of tens of nanometers or more. On the other hand, the removal of a surface FP monolayer of thickness of 1 to 2 nm degrades the ink contraction properties. These differences explain why no coating damages were detected by SEM for the LASQ coating after 1800 abrasions and a scratch was sensed using the ink contraction test after an LASQ-g-FP-6.0 coating was abraded for only 400 times (FIG. 6A).

Past studies used the decreases in the static contact angles and increases in the sliding angles of test liquids as measures for coating quality degradation. We monitored how these values changed for water and hexadecane as a function of the cycles (two strokes per cycle) of abrasion by steel wool under 26 kPa. The deterioration in these de-wetting properties of LASQ-g-FP-6.0 and LASQ-g-FP-2.7 is not substantial even after 1500 abrasion cycles. While these results suggest the high wear resistance of these coatings, they also show that this kind of test is not as sensitive as the ink contraction test. This conclusion is reasonable because the former probes the integrity of coating regions with sizes comparable with the contact area made by a probing liquid droplet with the coating (about 2 mm in diameter) and the latter allows the detection of micrometer-sized scars.

### Example 1H. Preparation of a Dual Action Anti-Smudge and Anti-Microbial Coating

This particular coating is both anti-smudge and anti-microbial. It is anti-smudge due to a liquid like moiety as described herein. However, the lodging of bacteria on such a coating can cause the surface of such a coating to reconstruct involving the emergence of a hydrophilic antimicrobial component in the coating from underneath. This newly exposed component kills bacteria. In one embodiment, the anti-smudge agent is PDMS. The anti-microbial component is quaternized N,N-dimethylaminoethyl methacrylate (qDMAEMA). To make such a coating, we first prepare a graft copolymer bearing a Boc-protected terminal amino group, which we denote as Boc-NH-(PDMAEMA-g-PDMS), where Boc denotes a tert-butoxycarbonyl protecting group. This synthesis involves the free radical copolymerization of DMAEMA and PDMS-MA (PDMS bearing a terminal methacrylate unit) in the presence of a chain transfer agent, 2-(Bocamino)ethanethiol. 2-Aminoethanethiol is protected with a Boc group because it is difficult to find a polymerization solvent that dissolves both PDMS-MA and 2-aminoethanethiol. The Boc group is next removed to yield NH₂-(PDMAEMA-g-PDMS). The amine terminated copolymer is subsequently grafted onto LASQ via a ring opening reaction of pendant epoxide groups to yield a doubly grafted copolymer, LASQ-g-(PDMAEMA-g-PDMS), which has a LASQ backbone bearing a PDMAEMA-g-PDMS graft copolymer side chain. Subsequent iteration improves grafting outcomes and simplifies the synthetic procedure by using a terminal carboxylic acid functionality to ring open pendant epoxide groups which is incorporated at the terminus of the polymer by the carboxylic acid containing initiator, 4,4′-azobis(4-cyanovaleric acid). Since the end group functionality is incorporated via the initiator rather than a chain transfer agent, all chains possess an end group functionality. After the quaternization of PDMAEMA, a coating is prepared from photocuring LASQ-g-(PqDMAEMA-g-PDMS) using an initiator. This coating is anti-smudge in air because the PDMS chains reside on the surface of the coating due to its low surface energy. Upon contact with the hydrophilic components of bacteria, the qDMAEMA groups emerge to contact bacteria and kill them.

### Synthesis of NH₂-(PDMAEMA-g-PDMS)

In a round bottom flask equipped with a stir bar, 0.23 g DMAEMA (1.5 mmol), 0.83 g PDMS-MA (0.92 mmol), 30 mg 2-(Bocamino) ethanethiol (0.17 mmol, 3.4 eq to AIBN), and 8 mg AIBN in (0.05 mmol, 2 mol % to monomer) were dissolved in 10 ml distilled THF. The reaction mixture was degassed with nitrogen gas for 30 min over ice, and the reaction was stirred at 65° C. for 24 h. The crude mixture was concentrated under reduced pressure and redissolved in 8 mL dichloromethane. The Boc group was cleaved with 0.3 mL trifluoroacetic acid added dropwise and stirred for 1 h. The resultant salt derivative was neutralized with 0.6 mL triethylamine added dropwise and stirred for 1 h. The crude mixture was washed with 1 mL water twice followed by 1 mL brine. The crude mixture was concentrated under reduced pressure and partially dissolved in 4 mL methanol. The mixture was washed thrice with 1 mL hexanes to remove unreacted PDMS-MA to yield an off-white solid. Mn=5900 Da, D=1.90.

### Synthesis of COOH-(PDMAEMA-g-PDMS)

In a round bottom flask equipped with a stir bar, 0.56 g DMAEMA (3.6 mmol), 0.10 g MA-PDMS₉₀₀ (0.41 mmol), 83 mg 4,4′-azobis(4-cyanovaleric acid) (ACVA, 0.30 mmol) were dissolved in 5 mL 2-propanol. The reaction mixture was degassed with nitrogen gas for 30 min over ice, and the reaction was stirred at 70° C. for 16 h. The mixture was concentrated under reduced pressure yielding a clear, tacky, gel. Mₙ=11,100 Da, D=2.3.

### Synthesis of LASQ-g-(PDMAEMA-g-PDMS)

Method I. LASQ (0.25 g, 1.4 mmol of epoxide groups) and NH₂-(PDMAEMA-g-PDMS) (23 mg, 3.8 μmol) were dissolved in 1.5 mL of 1:1 v/v butyl acetate/dimethylformamide in a round bottom flask equipped with a stir bar and reflux condenser. The reaction mixture was heated overnight at 115° C. Once cooled, the crude mixture was concentrated under reduced pressure and purified by precipitation into 10 mL hexanes. The precipitate was isolated by centrifugation and minimally dissolved in chloroform to be purified by precipitation into hexanes thrice. The resultant polymer was a light-yellow sticky solid.

Method II. LASQ (150 g, 0.846 mmol of epoxide groups), COOH-(PDMAEMA-g-PDMS) (130 mg, 11.7 μmol), and 42 μL triethylamine were dissolved in 2.6 mL of toluene, and the reaction mixture was heated overnight at 100° C. Once cooled, the crude mixture was concentrated under reduced pressure and purified by fractionation with 2-propanol and hexanes. The target polymer was isolated by centrifugation, and the resultant polymer was a light-yellow sticky solid.

### Synthesis of LASQ-g-(QPDMAEMA-g-PDMS)

In a round bottom flask equipped with a stir bar and reflux condenser, 0.10 g LASQ-g-(PDMAEMA-g-PDMS) (0.19 μmol of DMAEMA units) and 1-bromopropane or 1-iodohexane (0.954 mmol) were dissolved in a mixture of acetone and methanol. The reaction mixture was heated at 60° C. overnight. Excess 1-iodohexane was removed with a hexanes wash to yield a light-yellow gel.

### Preparation of LASQ-g-(PDMAEMA-g-PDMS) and LASQ-g-(QPDMAEMA-g-PDMS) Coatings

The glass substrate was first treated with ammonium bifluoride. The etched glass substrate was submerged in basic solution for 15 min and thoroughly rinsed with methanol. The substrate then underwent silanization by submersion in a 1 w/w % solution of 2-(3,4-epoxycyclohexyl)ethyltrimethoxysilane (ECTMS) in ethanol overnight. The glass substrate was then rinsed in fresh methanol for 15 min and annealed for 3 h at 100° C. under nitrogen gas.

To form a 40-μm-thick coating, 32 mg of LASQ-g-(PDMAEMA-g-PDMS) or LASQ-g-(QPDMAEMA-g-PDMS) and 5 μL of a triarylsulfonium hexafluoroantimonate salts solution (11.4 v % of the 50 wt % solution in propylene carbonate) were dissolved in 0.30 ml di(propylene glycol) methyl ether. The solution was casted onto a 1×1-inch pretreated glass, and the solvent was allowed to dry overnight at 60° C. under a gentle flow of nitrogen. The sample was photocured for 30 min with a focused beam from a 500-W mercury lamp passed through a 280 nm cut-off filter.

### Surface Properties of LASQ-g-(PDMAEMA-g-PDMS) and LASQ-g-(QPDMAEMA-g-PDMS)

Surface reconstruction of LASQ-g-(PDMAEMA-g-PDMS) and LASQ-g-(QPDMAEMA-g-PDMS) coatings were evaluated by time-dependent water contact angles. Table x lists the change in contact angles (θ) of 5 μL water over time (t) for unfunctionalized LASQ, LASQ-g-(PDMAEMA-g-PDMS), and LASQ-g-(QPDMAEMA-g-PDMS) coatings. For unfunctionalized LASQ coatings, there is a minimal change in contact angle over time (Δθ=4°). For the unquaternized LASQ-g-(PDMAEMA-g-PDMS) coatings, at initial contact with water (t=0 min), the high water contact angle indicates the presence of hydrophobic PDMS at the surface. At t=15 min, the water contact angle decreases to give Δθ=9° indicating the appearance of hydrophilic DMAEMA groups at the surface. The same properties are observed for quaternized LASQ-g-(QPDMAEMA-g-PDMS) coatings with a greater Δθ of 21°, indicating the emergence of quaternized DMAEMA to the surface.

### Example 1 I. Synthesis of a co-LASQ

A heavily crosslinked LASQ bearing surface dodecyl groups can repel water and oil. In this example, a co-LASQ bearing dodecyl and 2-(3,4-epoxycyclohexyl)ethyl groups at a molar ratio of 1/1 was synthesized. A mixture of water (0.37 mL, 2.0×10⁻² mol), THF (0.49 mL, 5.6×10⁻³ mol) and K₂CO₃ (6.2 mg, 4.5×10⁻⁵ mol) were stirred under nitrogen before the drop-wise addition of a pre-blended mixture of 2-(3,4-epoxycyclohexyl)ethyl trimethoxysilane (0.75 g, 3.1×10⁻³ mol) and dodecyltrumethoxysilane (0.89 g, 3.1×10⁻³ mol). After the mixture had been stirred for 5 d, 10 mL of dichloromethane was added to the mixture and the non-aqueous layer was extracted with water until neutral pH was reached. The non-aqueous layer was dried over MgSO₄ before being filtered and evaporation of the solvent under reduced pressure via rotary evaporation yielded a translucent oil.

### Example 1J. One-Pot Synthesis of PDMS-bearing LASQ

Monotriethoxysilylethyl-terminated polydimethylsiloxane (PDMS-TEOS) (Mn=500-1000 g/mol) (0.20 g) was pre-hydrolyzed in a mixture of THF (0.67 ml) and 0.50-M HCl solution (16 μl) at 60° C. for 4 h. After cooling, HCl was neutralize by adding 0.50-M NaOH solution (16 μl), followed by addition of 4.3 mg of K₂CO₃ in 0.49 mL of water. Then, 2-(3,4-epoxycyclohexyl)ethyltrimethoxysilane (ECTMS) (2.0 g) was added dropwise into the mixture while stirring under nitrogen. After stirring for 3 d, volatile components were removed via rotary evaporation. The residue was re-dissolved in 20.0 mL of dichloromethane and the non-aqueous layer was extracted with water until its pH became neutral. The non-aqueous layer was then dried over MgSO₄ and filtered. The solution was concentrated via rotary evaporation and the concentrate was added into excess hexanes to precipitate the polymer and remove unreacted PDMS-TEOS. LASQ-PDMS (1.14 g) as a semi-translucent sticky solid was obtained at a yield of 71%. The mass fraction of PDMS was quantified to be 2.8 wt. % via proton NMR.

### Example 1K. End Capping of LASQ by (CH₃)₃SiCl

LASQ (0.10 g) was dissolved in 1.50 mL of dry THF. Chlorotrimethylsilane (0.13 ml, 1.02 mmol) and triethylamine (0.20 ml, 1.43 mmol) was added to that mixture and stirred at 40° C. for 4 h. After the salt was filtered, the mixture was extracted in dichloromethane and water until pH=7. The non-aqueous layer was then dried over MgSO₄ and filtered. After solvent was removed via rotary evaporation, the end-capped LASQ was obtained as a white solid at a yield of 56%. This end-capping method stabilizes LASQ. LASQs reported in the literature are stable only when stored in solvents. Upon vacuum drying, LASQs can crosslink and become insoluble.

This method can be used to graft PDMS-CI and PDMS-H, which are PDMS groups that bear a terminal silyl chloride or silyl hydride group. Such a reaction can be used to prepare a block (“b”) copolymer such as LASQ-b-PDMS.

### Example 1L. One-Step Synthesis of Two Fluorinated co-LASQs

A mixture of 2-(3,4-epoxycyclohexyl)ethyltrimethoxysilane (ECTMS) (2.0 g, 8.1 mmol) and 1H,1H,2H,2H-perfluorodecyltrimethoxysilane (0.24 g, 0.42 mmol) (FC8-TMS) was added dropwise under nitrogen into a clear mixture of water (0.51 mL), tetrahydrofuran (THF, 0.68 mL), and potassium carbonate (4.4 mg). After the mixture had been stirred for 3 d, volatile components were removed via rotary evaporation. The solid residue was re-dissolved in 20 mL of dichloromethane and the non-aqueous layer was extracted with water until its pH became neutral. The non-aqueous layer was then dried over MgSO₄ and filtered. Evaporation of the solvent via rotary evaporation yielded LASQ-FC8 as semi-translucent sticky solids (1.62 g, 98% yield). Similarly, LASQ-FC6 (LASQ bearing perfluorinated hexyl groups) was also obtained following the same procedure but using 1H,1H,2H,2H-perfluorooctyltrimethoxysilane (FC6-TMS) as a monomer for copolymerization with ECTMS.

### Example 1K. Effect of Using a Surfactant for Making Co-LASQ

A heavily crosslinked LASQ bearing surface dodecyl groups can repel water and oil. In this example, a co-LASQ bearing dodecyl and 2-(3,4-epoxycyclohexyl)ethyl groups at a molar ratio of 1/1 was synthesized. A mixture of THF (0.16 mL) and 0.3M KOH (0.9 ml) were stirred under nitrogen before the drop-wise addition of a pre-blended mixture of 2-(3,4-epoxycyclohexyl)ethyl trimethoxysilane (0.25 g) and dodecyltrumethoxysilane (0.3) were added dropwise. Sodium dodecyl sulfate (SDS) (15 mg) was then added to the reaction. The inclusion of the surfactant, sodium dodecyl sulfacte increases the reaction rate of the copolymerization and reduces the overall reaction time required for polymerization to occur.

FIG. 8A shows SEC traces of the reaction performed in the absence of surfactant, and in the presence of surfactant. Polymerization can be seen after 1 day in the sample where the surfactant is present. Polymerization can be seen at the 3 day timepoint in the absence of surfactant.

### Example 1L. Effect of Varying Reaction Time on the Molecular Weight of the Synthesized Co-LASQ

A heavily crosslinked LASQ bearing surface dodecyl groups was prepared and was shown to repel water and oil. A co-LASQ bearing dodecyl and 2-(3,4-epoxycyclohexyl)ethyl groups at a molar ratio of 1/1 was synthesized. A mixture of THF (0.16 mL) and 0.3M KOH (0.9 mL) were stirred under nitrogen. A pre-blended mixture of 2-(3,4-epoxycyclohexyl)ethyl trimethoxysilane (ECTMS) and dodecyltrumethoxysilane (DTMS) were added dropwise to the mixture at a molar ratio of 8:1. Sodium dodecyl sulfate (SDS) (15 mg) was then added.

For kinetic study of the copolymerization to yield LASQ, samples were drawn through a syringe under nitrogen protection after 6, 24, and 48 hours. To stop the polymerization after a sample was taken, 0.09 mL of 0.3 M HCl was added to neutralize the samples. Sample were dried via rotary-evaporation. Chloroform was added to the sample residue and the non-aqueous phase was extracted with water to remove SDS. After the chloroform layer was dried with MgSO₄ and filtered, size-exclusion chromatography (SEC) analyses of the samples were conducted immediately. SEC traces are shown in FIGS. 8A-8C.

### Example 1M. Effect of Type and Concentration of Photoinitiator on Co-LASQ Curing

Casting a LASQ solution containing 1.25 wt % of photoinitiator triarylsulfonium hexafluoroantimoante on a glass slide or PET substrate and waiting for solvent evaporation yielded a LASQ film. The film thickness was regulated by controlling the mass of LASQ cast per unit substrate area. Photolysis with UV light of the cured LASQ film provided a coating. Alternatively, casting a LASQ solution containing either 3 wt % or 6 wt % of photoinitiator (e.g., 4 methylthio phenyl)methyl phenyl sulfonium triflate on a glass slide or PET substrate and waiting for solvent evaporation provided a LASQ film. The photoinitiator used and the weight percentage of photoinitiator had an effect on the hardness of the resulting film. See Table 7 for hardness data for specified samples.

### Example 1N. Effect of Varying Dodecyltrumethoxysilane (DTMS) Molar Fraction in Co-LASQ of a Final Coating

A heavily crosslinked LASQ bearing surface dodecyl groups was prepared and shown to repel water and oil. A co-LASQ bearing dodecyl and 2-(3,4-epoxycyclohexyl)ethyl groups at a molar ratio of 1/1 was synthesized. A mixture of THF (0.16 mL) and 0.3M KOH (0.9 ml) were stirred under nitrogen. A pre-blended mixture of 2-(3,4-epoxycyclohexyl)ethyl trimethoxysilane and dodecyltrumethoxysilane (DTMS) were added dropwise to the mixture at variable molar ratios. Sodium dodecyl sulfate (SDS) (15 mg) was then added to the reaction.

An LASQ solution containing 1.25 wt % of photoinitiator triarylsulfonium hexafluoroantimoante was cast on a glass slide or PET substrate and solvent evaporated to yield a LASQ film. The film thickness was regulated by controlling the mass of LASQ cast per unit of substrate area. Changing the molar ratio of ECTMS relative to DTMS impacted the hardness of the film. A 2:1 ration of ECTMS to DTMS exhibited a hardness of 0.23±0.05 GPa. A 4:1 ration of ECTMS to DTMS exhibited a hardness of 0.84±0.17 GPa. A 8:1 ration of ECTMS to DTMS exhibited a hardness of 0.96±0.13 GPa.

### Example 2. Surface Properties of m-LASQ-LASQ-bf Coatings

### Example 2A. Characterization

Surface properties of the m-LASQ-LASQ-bf coatings were characterized by determining their surface composition, energies, liquid sliding angles, contact angle hysteresis, and their ink contraction behavior.

Surface compositions of the m-LASQ-LASQ-bf coatings were determined by XPS. Such analyses yielded the surface F atomic contents of 40.5% and 39.8% for a LASQ-g-FP-2.7 and LASQ-g-FP-6.0 coating, respectively. That these numbers are much higher than the calculated bulk F atomic abundances of 2.1% and 4.9% suggested the enrichment of the coating surfaces by a grafted FP monolayer. However, the reversal of the determined F contents for the two samples is counter-intuitive but may be due to experimental errors. The F atomic abundance does not reach 60% expected for a neat FP liquid because the FP monolayer is not dense or/and thick enough.

Regarding surface energy, a liquid-like FP layer greatly reduced the surface energy of a m-LASQ-LASQ-bf coating. Table 2 lists the contact angles θ of 5-μL water and hexadecane droplets as well as 3-μL diiodomethane droplets on LASQ, LASQ-g-FP-2.7, and LASQ-g-FP-6.0 coatings. The contact angles of the three different test liquids are higher on the LASQ-g-FP-6.0 coating than on the LASQ-g-FP-2.7 coating.

Using the 0 values and the literature polar component, γ_{SV}^{p}, and dispersive component, γ_{SV}^{d}, of the surface energies of these liquids and the Owen, Wendt, Rabel, and Kaeble (OWRK) method (Owens, D. K., et al., J. Appl. Polym. Sci. 1969, 13, 1741-47), the γ_{SV}^{p} and γ_{SV}^{d} values as well as the total surface energies γ_{SV} of the different coatings (see Table 2).

The introduction of FP greatly increased the contact angles of the tested liquids and drastically decreased the surface energies of the LASQ coating. The surface energy of the LASQ-g-FP-6.0 coating reached a low value of 12.3±1.5 mJ/m².

Although one may argue against the statement that the surface energy of 12.3±1.5 mJ/m² for the LASQ-g-FP-6.0 coating is lower than 13.4±1.2 mJ/m² for the LASQ-g-FP-2.7 coating, the contact angles of the three test liquids were unambiguously greater on the former than on the latter coating. These results suggested that the LASQ-g-FP-6.0 coating surface was better covered by FP than the LASQ-g-FP-2.7 coating surface.

Dynamic de-wetting properties of the LASQ and m-LASQ-LASQ-bf coatings were characterized by the sliding angles (SA), advancing contact angles (θ_{A}), and receding contact angles (θ_{R}) of the three test liquids mentioned above. The results are listed in Table 3.

Increasing fluorine content from 2.7 wt % to 6.0 wt % decreases the SAs and contact angle hysteresis θ_{A}-θ_{R} slightly. The small differences between the values on the LASQ-FP2.7 and LASQ-g-FP-6.0 coatings suggest the strong tendency for FP to surface-stratify even at a bulk fluorine content of 2.7 wt %, in agreement with the XPS data.

Interestingly, the SAs were somewhat higher on the LASQ-FP coatings than on similar NP-GLIDE coatings bearing surface PDMS chains. Although not wishing to be bound by theory, the inventors suggest that one possible reason is that the surface FP chains were not swollen regardless of the test liquid used and the collapsed FP layer was less dynamic than a PDMS layer swollen by hexadecane or diiodomethane, for example. Additionally, the FP chains are shorter than the PDMS chains that were normally used and may not cover the surface of the base coating as well as the PDMS chains did.

### Example 2B. Ink Contraction and Removal

The m-LASQ-LASQ-bf coatings were developed with potential application on hand-held electronic devices and appliances etc. For these applications, the coating's ability to resist smudge contamination is of importance. Tests show that the ink of a Sharpie permanent marker spreads well on a LASQ coating. However, it facilely contracts on the LASQ-g-FP-2.7 and LASQ-g-FP-6.0 coatings. Thus, the m-LASQ-LASQ-bf coatings impede contamination by ink, a smudge simulant. Our quantitative analyses suggest that the final puddles covered only 3.6±0.1% and 2.8±0.1% of the original ink-writing areas on the LASQ-g-FP-2.7 and LASQ-g-FP-6.0 coatings, respectively. More importantly, the dried ink marks could be readily wiped off with Kimwipe tissue from these two coatings. However, the ink could not be removed from LASQ coating. Thus, the m-LASQ-LASQ-bf coatings have superb anti-smudge properties.

### Example 2C. Nanoindentation

Nanoindentation hardness H, effective Young's modulus (E), and work recovery (wₑ) were obtained of 40-μm-thick coatings of LASQ photolyzed for different times. FIG. 3B shows that H increased from 1.32±0.06 to 1.48±0.02 GPa when the photolysis time was increased from 5 to 20 min but remained essentially unchanged after 20 min. Therefore, 20 min was used for the curing of subsequent coating samples.

Nanoindentation analyses were also performed of 40-μm-thick coatings prepared from the fractionated LASQ samples. Table 1 shows that the H values are similar for coating samples of F1, F2, and the unfractionated LASQ, which all have M_{w}>1.0×10⁴ Da, but decrease substantially from the F3 to F4 coating when the LASQ M_{w} decreases below ˜1.0×10⁴ Da. Since H has been shown to be directly correlated with the wear resistance of previously-studied POSS coatings (Bender, D. N. et al., ACS Appl. Mater. Interfaces 2021, 13, 10467-79). it was decided to focus on coatings prepared from unfractionated LASQ or m-LASQ-LASQ-bf derived from reacting FP-COOH with unfractionated LASQ.

H, E, and wₑ values of 40-μm-thick LASQ-FP2.7 and LASQ-FP6.0 coatings are shown in Table 4 for comparison with those of two common plastics, polystyrene (PS) and PET, as well as the LASQ base coating. Table 4 suggests that cured LASQ has an H value that is 9.3±1.2 times that of PET and is indeed a remarkably hard material.

The incorporation of liquid FP decreases H somewhat. However, cured LASQ-FP6.0 still possesses a remarkable H value of 1.39±0.04 GPa. This value is almost twice as high as 0.70 GPa for cured GPOSS coating.

Decreasing the thickness of the LASQ-FP6.0 coating reduces the H value somewhat. However, H of 10-μm-thick LASQ-FP6.0 coating samples is still remarkably high at 1.22±0.04 GPa. The decrease in H with decreasing coating thickness has been previously attributed to the increasing contributions made by the interfacial forces between the coating and glass to the measured H value. (Choi, G. M., et al., Adv. Mater. 2017, 29, 1700205-12). For a hard coating like LASQ, the cohesive forces in the coating matrix may be greater than the interfacial forces.

The measured H of an m-LASQ-LASQ-bf coating decreases when the coating's substrate is changed from glass to PET. This effect is well known. A PET backing film can yield more readily than glass during the indentation process, resulting in a sink-in effect and an overestimated contact area between the indenter tip and the coating and thus an underestimated H. (Tayebi, N., et al., J. Mater. Res. 2011, 19, 1791-802).

The E and wₑ values have been included because H/E>10% and wₑ>60% have been previously cited as criteria for hard flexible coatings. While our LASQ-FP coatings meet such criteria, we remind readers that such criteria should be used with caution because the H value reported for a given sample by different groups can vary substantially.

### Example 2D. Pencil Hardness

LASQ and m-LASQ-LASQ-bf coatings, 40 μm thick on glass plates, could not be scratched with the hardest pencil and thus have the highest rating of 9H (Table 4). This is in contrast to the scratching of a 125-μm-thick PET film and a 100-μm-thick PS film on glass by the softest 9B pencil.

Like H values, the pencil hardness decreases as the thickness of an m-LASQ-LASQ-bf coating on glass decreases. Despite this, a 10-μm-thick LASQ-FP6.0 coating still has an impressive high pencil hardness of 5H. Pencil hardness of a 40-μm-thick LASQ-FP6.0 coating also decreases when glass is replaced with PET as the substrate (Table 4). This result again agrees with the H variation trend.

### Example 2E. Bendability

Flexibility of the coatings was assessed by bending 10-μm-thick coatings of LASQ and its fractions on 50-μm-thick PET films around steel rods of decreasing diameters using a bending tester. Such a test provided a critical bending diameter below which a coating cracked. When the coatings were placed against the metal rods undergoing inward bending, all coatings could roll around a 2-mm rod without cracking. Since the rod with a diameter was the smallest rod provided for such a test, smaller rods have not yet been used to test coating bending around smaller rods, the critical diameter for inward bending involving coating compression was <2 mm for all the samples. Table 1 lists the critical diameters for the different coatings undergoing outward bending with the PET supporting films pressed against the steel rods and the coating facing outwards. The critical diameter was <4 mm for all coatings except the F1 coating, which has a critical outward bending diameter of <3 mm. The finding that critical outward bending diameters were larger than inward bending diameters suggested that the coatings were more susceptible to extension failure during outward bending than to compression failure during inward bending. Notably, bending properties of the LASQ coatings are comparable with those of cured POSS coatings (Bender, D. N., et al., ACS Appl. Polym. Mater. 2022, 4, 1878-89).

Incorporation of liquid FP into to LASQ does not seem to increase the flexibility of the resultant fluorinated coating. Coatings of LASQ, LASQ-FP2.7, and LASQ-FP6.0, regardless of their thickness between 10 and 40 μm on 50-μm-thick PET films, exhibited inward bending diameters of <2 mm. The LASQ-FP6.0 coating had the same outward bending diameter of 4 mm as a LASQ coating at an equal thickness of 10 μm. As the thickness of the LASQ-FP6.0 coating increases from 10 to 20, 30, and 40 μm, the critical outward bending diameter increases from 4 to 5, 6, and 8 mm, respectively. At a fixed thickness of 40 μm, the critical outward bending diameter remains at 8 mm regardless of F content increase from 0 to 2.7% and then to 6.0%.

A bending durability test was performed of a 10-μm-thick LASQ-FP6.0 coating. After this sample was subjected to 200 times of outward bending to a diameter of 4 mm, no sign of coating degradation or detachment from the PET substrate was noticed. Such a coating contracted ink just as effectively as the pristine coating (see FIGS. 5-6B).

### Example 2F. Abrasion Resistance

LASQ and m-LASQ-LASQ-bf coatings were subjected to abrasion by steel wool to assess their wear resistance. This is a harsh test. PS, PET, and crosslinked polyurethane cannot survive even a single such abrasion stroke without sustaining damage.

After a G₂M₆POSS (i.e., POSS bearing two glycidyl groups and six methacrylate groups) coating was abraded 1600 times with steel wool under a pressure of 26 kPa, a few wearing streaks were detected by SEM on it. Notably, no wearing streaks were detected at all on a LASQ coating even after 1800 abrasions. Thus, the LASQ coating with a higher H value is indeed more wear resistant than the G₂M₆POSS coating.

### Example 3. Preparation of LASQ-PDMS

The following procedures details how various LASQ-PDMS polymers were prepared.

### LASQ-PDMS₁₀ₖ-6.0

To prepare LASQ-PDMS₁₀ₖ-6.0: LASQ-PDMS₁₀ₖ containing 6.0% PDMS (mass fraction): LASQ (1.9 g), PDMS₁₀ₖ-COOH (0.5 g, 0.05 mmol), triethylamine (0.6 mL, 5.93 mmol) and toluene (12 mL) were stirred to form a mixture, which was then heated at 105° C. for 48 hours. The mixture was cooled down to room temperature. The mixture was concentrated under reduced pressure via rotary-evaporation to form a concentrate. The concentrate was added into a volume of hexanes that is approximately 7 times the volume of the concentrate, to precipitate a polymer. The polymer solution was centrifuged at 7000 rpm (i.e., 7996×g) for 10 min. After supernatant removal via decantation, a solid product was dried in a 60° C. vacuum oven for 30 min. An orange sticky solid (1.5 g, 62.5% yield) was obtained.

LASQ-PDMS₅ₖ-2.7 and LASQ-PDMS_{5K}-8.7

To prepare LASQ-PDMSd₅ₖ-2.7 and LASQ-PDMS₅ₖ-8.7: a similar procedure to the above one was used, but the feeds of PDMS₅ₖ-COOH were changed to 5.2 and 15.1 wt. %, respectively. The amount of toluene used decreased from 6.3 times to 4.1 times relative to LASQ.

### Example 4. Preparation of LASQ-PDMS Ice-Shedding Coating

Five 30 μm-thick coatings were prepared by combining one of the LASQ-PDMS polymers (120 mg) with mixed salts of triarylsulfonium hexafluoroantimonate (TSHFA) (2.13 μL of 50 wt % in propylene carbonate). This combination was added to 0.50 mL of propylene glycol methyl ether acetate (PGMEA) to form a mixture. This mixture was then filtered through cotton, equally divided, and cast onto five G10/FR4 glass epoxy sheets (1×1 inch²). The coatings were allowed to evaporate overnight at 60° C. under a gentle flow of nitrogen. The samples were then photolyzed with UV light for 20 min with a focused beam from a 500 W mercury lamp that passed through a 280 nm cutoff filter. The density of LASQ-PDMS was assumed to be 1.25 g/mL and coating thickness was confirmed using a micrometer.

### Example 5. Testing of LASQ-PDMS Ice-Shedding Coating

As shown in Table 5, τ values of LASQ-PDMS coatings decreased compared to pristine LASQ films, because of the surface PDMS layer. The LASQ film has a τ value of 312±19 kPa while the T values for LASQ-PDMS₅ₖ-2.7 was 37.1±11.8; the τ values for LASQ-PDMS₅ₖ-8.7 was 22.7±6.1; and the τ values for LASQ-PDMS₁₀ₖ-6.0 was 20.1±6.2 kPa. The reduction in T values is less dramatic in the case of LASQ-PDMS₅ₖ-2.7. The lower molecular weight of grafted PDMS resulted in higher T values and stronger ice adhesion. As the grafted mass fraction increased, the T values decreased.

T values of silicone oil-lubricated LASQ-PDMS₅ₖ coatings were 2 orders of magnitude lower than those observed for LASQ coatings. This result indicated excellent ice-shedding properties of the lubricated LASQ-PDMS₅ₖ coatings. Furthermore, lubricated LASQ-PDMS₁₀ₖ-6.0 samples demonstrated superior ice-shedding performance with τ values ranging from 0.3 to 1.5 kPa, which were at least 200 times lower than those of pristine LASQ coatings.

As shown in FIGS. 7A and 7B, long-term ice-shedding performances of the lubricated LASQ-PDMS coatings were evaluated by conducting icing/deicing cycles on five specimens for each coating. A mixture of two silicone oils of viscosities 2 cSt and 50 cSt. These SOs were mixed in a ration of 2:1, with the higher amount being the 2 cSt SO. 2+50 cSt SO and 5 cSt SO-lubricated LASQ-PDMS₅ₖ-8.7 performed similarly well and the lubricant (each SO mixture or pure sample) was not depleted after at least 25 icing and deicing cycles. SO-lubricated LASQ-PDMS₁₀ₖ-6.0 coatings exhibited better long-term ice-shedding performance relative to LASQ-PDMS₅ₖ-8.7, as shown in FIGS. 7A and 7B by a lower ice adhesion strength and thus more ability to shed ice. Especially for the combination of 5 cSt SO and 50 cSt SO, and the combination of 5 cSt SO and D2 SO, ice adhesion strengths were below 5 kPa in the first 19 cycles and maintained lower or at approximately 10 kPa after 30 cycles. Using silicone oil combinations including a SO with a higher viscosity can improve the long-term ice-shedding properties of LASQ-PDMS₁₀ₖ-6.0 coatings because the SO with higher viscosity is less likely to get lost during icing/deicing cycles. By adding high viscosity or high molecular weight silicone oil into the coating, T values were lower.

### Example 6. Surface Properties of LASQ-g-(PDMAEMA-g-PDMS) and LASQ-g-(QPDMAEMA-g-PDMS)

Surface reconstruction of LASQ-g-(PDMAEMA-g-PDMS) and LASQ-g-(QPDMAEMA-g-PDMS) coatings were evaluated by time-dependent water contact angles. Table 6 lists the change in contact angles (θ) of 5 μL water over time (t) for unfunctionalized LASQ, LASQ-g-(PDMAEMA-g-PDMS), and LASQ-g-(QPDMAEMA-g-PDMS) coatings. For unfunctionalized LASQ coatings, there was minimal change in contact angle over time (Δθ=4°). For the unquaternized LASQ-g-(PDMAEMA-g-PDMS) coatings, at initial contact with water (t=0 min), the high water contact angle indicated the presence of hydrophobic PDMS at the surface. At t=15 min, the water contact angle decreased to give Δθ=9°, which indicated the appearance of hydrophilic DMAEMA groups at the surface. The same properties were observed for quaternized LASQ-g-(QPDMAEMA-g-PDMS) coatings with a greater Δθ of 21°, indicating the emergence of quaternized DMAEMA at the surface.

### Example 7. Ice Adhesion Measurement

To infuse LASQ-PDMS coatings with lubricant such as silicone oil (SO), SO with a desired viscosity was used, or a mixture of SOs of different viscosities were mixed in hexanes to a concentration of 150 mg/mL. SO or SO solutions (100 μL) were cast onto cured LASQ-PDMS coatings, followed by equilibration for at least 16 hours at 60° C. under a gentle flow of nitrogen.

To quantify the ice adhesion of an LASQ-PDMS infused with lubricant, ice columns were first prepared on the lubricated coating sample. Polystyrene cuvettes with internal dimensions of 10×10×43 mm³ were used. The cuvettes were cut to expose their bottom side. The cuvette was placed upside down onto a lubricated LASQ-PDMS coating sample that was stored in a −20° C. freezer. Deionized water (0.90 mL) was dispensed into the cuvette through the exposed end. Ice formation was allowed to develop for at least 1 hour.

Ice adhesion strength (“τ”) was measured using a custom apparatus that included a force probe, a syringe pump, and a cooling stage. The distance between the lowest point of the force probe head and the coating was ˜1.0 mm. After ice formation, one coating sample bearing an ice column was immediately mounted onto the sample stage. The sample stage was regulated at the lowest achievable temperature of −11° C. using a Peltier cooler. The syringe pump that drove the force probe was immediately engaged to push the force probe forward toward the ice column at a speed of 0.023 mm/s. The maximum force required to remove the ice column was recorded, and the corresponding ice adhesion strength (T) was calculated by dividing the force by the cross-sectional area (1.00 cm²). The reported ice adhesion strength (T) value for each sample was the average of five specimens prepared in parallel. See FIGS. 7A and 7B.

### Example 8. Bifunctional LASQ

This synthesis was conducted as described in Example 1A, and the reaction scheme is shown in FIG. 1C.

### EQUIVALENTS

It will be understood by those skilled in the art that this description is made with reference to certain embodiments and that it is possible to make other embodiments employing the principles of the invention which fall within its spirit and scope.

TABLE 1
Molecular characteristics of LASQ and its fractions as well
as the mechanical properties of cured LASQ and LASQ fractions.
While the nanoindentation data were determined for 40-μm-thick
coatings on glass plates, the bending radii were determined
for 10-μm-thick coatings on PET.

| | SEC | | | | | Outward |
|---|---|---|---|---|---|---|
| | 10⁴ × | | | | | Bend |
| | M_{w} | M_{w}/ | | | | Diameter |
| Sample | (Da) | Mₙ | H (GPa) | E (GPa) | wₑ | (mm) |
| LASQ | 2.0 | 3.54 | 1.48 ± 0.02 | 7.0 ± 0.1 | 81 ± 1% | 4 |
| F1 | 3.8 | 1.68 | 1.54 ± 0.07 | 8.3 ± 0.1 | 66 ± 2% | 3 |
| F2 | 1.41 | 1.23 | 1.49 ± 0.08 | 7.5 ± 0.3 | 79 ± 2% | 4 |
| F3 | 0.82 | 1.30 | 1.36 ± 0.04 | 7.0 ± 0.4 | 69 ± 4% | 4 |
| F4 | 0.53 | 1.31 | 0.95 ± 0.03 | 5.1 ± 0.2 | 67 ± 1% | 4 |

TABLE 2
Liquid Contact angles and surface energies γ_{SV},
and their dispersive γ_{SV}^{d}, and polar components γ_{SV}^{p}
of LASQ, LASQ-FP2.7, and LASQ-FP6.0 coatings.

| | H₂O | CH₂I₂ | C₁₆H₃₄ | γ_{SV} | γ_{SV}^{d} | γ_{SV}^{p} |
|---|---|---|---|---|---|---|
| Coating | θ (°) | θ (°) | θ (°) | (mJ/m²) | (mJ/m²) | (mJ/m²) |
| LASQ | 81 ± 2 | 35 ± 1 | 14 ± 2 | 36.6 ± 6.6 | 31.5 ± 5.9 | 5.1 ± 2.7 |
| LASQ- | 111 ± 1 | 91 ± 1 | 66 ± 1 | 13.4 ± 1.2 | 12.6 ± 1.1 | 0.8 ± 0.3 |
| FP2.7 | | | | | | |
| LASQ- | 114 ± 1 | 94 ± 1 | 68 ± 1 | 12.3 ± 1.5 | 11.7 ± 1.4 | 0.5 ± 0.3 |
| FP6.0 | | | | | | |

TABLE 3
SAs, θ_{A}, and θ_{R} values for 15-μl water droplets and 5-μl diiodomethane
and hexadecane droplets on LASQ, LASQ-FP2.7, and LASQ-FP6.0 coatings.

| | LASQ Coating | | | LASQ-FP2.7 Coating | | | LASQ-FP6.0 Coating | | |
|---|---|---|---|---|---|---|---|---|---|
| Liquid | SA (°) | θ_{A} (°) | θ_{R} (°) | SA (°) | θ_{A} (°) | θ_{R} (°) | SA (°) | θ_{A} (°) | θ_{R} (°) |
| H₂O | 74 ± 4 | 84 ± 3 | 60 ± 3 | 37 ± 1 | 112 ± 2 | 100 ± 1 | 32 ± 1 | 112 ± 2 | 103 ± 1 |
| CH₂I₂ | 18 ± 2 | 54 ± 2 | 26 ± 3 | 14 ± 1 | 90 ± 3 | 76 ± 2 | 12 ± 2 | 95 ± 1 | 83 ± 2 |
| C₁₆H₃₄ | Spread | | | 29 ± 2 | 71 ± 1 | 57 ± 2 | 27 ± 1 | 72 ± 1 | 60 ± 2 |

TABLE 4
H, E, and wₑ values as well as pencil hardness
and bendability of different materials.

| Coating or | Pencil | | | | Outward Bend |
|---|---|---|---|---|---|
| Thickness | Hardness | H (GPa) ^{a} | E (GPa) | wₑ | Diam. (mm) ^{b} |
| PET ^{c} | <9B | 0.16 ± 0.02 | 0.56 ± 0.09 | 73 ± 3% | 1 |
| PS | <9B | 0.25 ± 0.01 | 5.9 ± 0.3 | 19 ± 1% | >16 |

40-μm-thick coatings

| | | | | | |
|---|---|---|---|---|---|
| LASQ | 9H | 1.48 ± 0.02 | 7.0 ± 0.1 | 81 ± 1% | 8 |
| LASQ-FP2.7 | 9H | 1.40 ± 0.04 | 6.5 ± 0.3 | 81 ± 1% | 8 |
| LASQ-FP6.0 | 9H | 1.39 ± 0.04 | 6.4 ± 0.2 | 81 ± 1% | 8 |

40-μm-thick coating on 125-μm-thick PET

| | | | | | |
|---|---|---|---|---|---|
| LASQ-FP6.0 | 4H | 0.46 ± 0.04 | 1.14 ± 0.09 | 89 ± 2% | NA ^{d} |

LASQ-FP6.0 coating at different thickness

| | | | | | |
|---|---|---|---|---|---|
| 30 μm | 9H | 1.36 ± 0.03 | 6.4 ± 0.1 | 81 ± 1% | 6 |
| 20 μm | 8H | 1.22 ± 0.04 | 5.8 ± 0.2 | 79 ± 1% | 5 |
| 10 μm | 5H | 1.20 ± 0.07 | 6.0 ± 0.3 | 72 ± 1% | 4 |

^{a} Nanoindentation measurements done of coatings prepared on glass plates unless mentioned otherwise.
^{b} Bending was done on coatings prepared on 50-μm-thick PET films.
^{c} The 125-μm-thick PET film was used in the test. The outward bend diameter is the same as inward bend diameter in this case.
^{d} Not measured on this thick PET substrate but on a 50-μm-thick PET film.

TABLE 5
Ice Adhesion Strength (τ) of Various Coatings or Substrates.

| Film or Lubrication | τ (kPa) |
|---|---|
| Glass Epoxy (FR4) | 290 ± 40 |
| LASQ | 312 ± 19 |
| LASQ-PDMS₅ₖ-2.7 No SO | 37.1 ± 11.8 |
| LASQ-PDMS₅ₖ-2.7 5/50 cSt | 3.2 ± 3.7 |
| LASQ-PDMS₅ₖ-8.7 No SO | 22.7 ± 6.1 |
| LASQ-PDMS₅ₖ-8.7 2 cSt | 4.1 ± 3.2 |
| LASQ-PDMS₅ₖ-8.7 5 cSt | 3.0 ± 1.4 |
| LASQ-PDMS₅ₖ-8.7 2/50 cSt | 1.2 ± 0.6 |
| LASQ-PDMS₅ₖ-8.7 5/50 cSt | 2.1 ± 1.3 |
| LASQ-PDMS₁₀ₖ-6.0 No SO | 20.1 ± 6.2 |
| LASQ-PDMS₁₀ₖ-6.0 2 cSt | 0.9 ± 0.4 |
| LASQ-PDMS₁₀ₖ-6.0 5 cSt | 0.3 ± 0.4 |
| LASQ-PDMS₁₀ₖ-6.0 50 cSt | 0.3 ± 0.2 |
| LASQ-PDMS₁₀ₖ-6.0 2/50 cSt | 1.0 ± 0.4 |
| LASQ-PDMS₁₀ₖ-6.0 5/50 cSt | 1.3 ± 1.5 |
| LASQ-PDMS₁₀ₖ-6.0 5 cSt/D2 | 0.5 ± 0.5 |

TABLE 6
Time-dependent water contact angles of coatings

| | H₂O | H₂O |
|---|---|---|
| | θ (°) at | θ (°) at |
| Coating | t = 0 min | t = 15 min |
| LASQ | 96 ± 2 | 92 ± 0 |
| LASQ-g-(PDMAEMA-g-PDMS) | 104 ± 2 | 95 ± 6 |
| LASQ-g-(qPDMAEMA-g-PDMS) | 102 ± 2 | 81 ± 6 |

TABLE 7
Comparison of hardness versus photoinitiator

| Sample | Photoinitiator | Hardness (GPa) |
|---|---|---|
| LASQ | triarylsulfonium | 1.22 ± 0.03 |
| | hexafluoroantimoante | |
| LASQ | (4 methylthio phenyl) methyl | 0.83 ± 0.04 |
| | phenyl sulfonium triflate (6 | |
| | wt %) | |
| 8:1 Copolymerized | (4 methylthio phenyl) methyl | 0.46 ± 0.06 |
| LASQ | phenyl sulfonium triflate (3 | |
| T = 1 Day | wt %) | |
| 8:1 Copolymerized | (4 methylthio phenyl) methyl | 0.64 ± 0.05 |
| LASQ | phenyl sulfonium triflate (6 | |
| T = 1 Day | wt %) | |
| 8:1 Copolymerized | (4 methylthio phenyl) methyl | 0.43 ± 0.07 |
| LASQ | phenyl sulfonium triflate (3 | |
| T = 2 Days | wt %) | |
| 8:1 Copolymerized | (4 methylthio phenyl) methyl | 0.62 ± 0.04 |
| LASQ | phenyl sulfonium triflate (6 | |
| T = 2 Days | wt %) | |

1. A polymer of formula 1 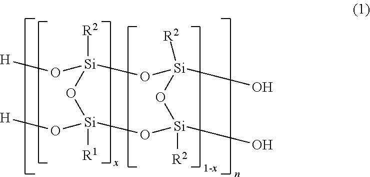
where
n is 1 to 1000,
x is 0.01 to 1,
R¹ comprises a liquid-like moiety, and
R² comprises a crosslinkable moiety.

2. The polymer of claim 1, wherein n is 1 to 100.

3. The polymer of claim 1, wherein R¹ comprises:
perfluorinated poly(propylene oxide); poly(dimethyl siloxane) (PDMS);
dodecyl; perfluorinated hexyl; iso-dodecyl; poly(N,N-dimethylamino methacrylate)-g-PDMS;
oligo (ethylene oxide); poly(2-ethylhexyl macrylate); polyisobutylene; or a combination thereof.

4. The polymer of claim 1, wherein R² comprises:
epoxide; vinyl; acrylate; methacrylate; aryl; heteroaryl; vinyl; aziridine; amino; carboxy; hydroxy;
thiol; anhydride; phosphino; silane (SiH); or a combination thereof.

5. A cured coating, comprising ladder-like polysilsesquioxane that has a liquid-like moiety.

6. The coating of claim 5, wherein the coating is highly transparent.

7. The coating of claim 5, wherein the coating is omniphobic.

8. The coating of claim 5, wherein the coating is wear resistant.

9. The coating of claim 5, wherein the coating has high hardness.

10. The coating of claim 5, wherein the coating is flexible.

11. (canceled)

12. The coating of claim 1, wherein the coating has a F mass fraction in a range of 0.1% to 20%.

13. (canceled)

14. The coating of claim 6, wherein the coating has a surface energy of about 5 to about 40 mJ/m².

15. (canceled)

16. An uncured coating precursor comprising:
the compound of Formula 1 of claim 1, and, optionally, LASQ.

17.-19. (canceled)

20. The coating of claim 6, comprising of LASQ derived from
isobutyltrimethoxysilane, n-propyltrimethoxysilane, hexyltrimethoxysilane, cyclohexyltrimethoxysilane, phenyltrimethoxysilane, PDMS bearing a terminal trimethoxysilyl group, perfluorinated polyether (PFPE) bearing a terminal trimethoxysilyl group, perfluorododecyltrimethoxysilane, perfluorotridecyltrimethoxysilane, perfluorodecyltrimethoxysilane, perfluorooctyltrimethoxysilane, perfluorohexyltrimethoxysilane, decyltrimethoxysilane, dodecyltrimethoxysilane, isododecyltrimethoxysilane, 2-(3,4-epoxycyclohexyl)ethyltrimethoxysilane, (3-glycidyloxypropyl) trimethoxysilane, (3-methacryloxypropyl) trimethoxysilane, (3-acryloxypropyl) trimethoxysilane, (3-aminopropyl) trimethoxysilane, or a combination thereof.

21.-34. (canceled)

35. A method for shedding accumulated material, comprising:
applying the coating precursor of claim 16 to a substrate;
curing the applied coating precursor to form a crosslinked coating, wherein accumulated material on the coating readily sheds.

36. A method for providing an antimicrobial coating comprising:
applying the polymer of claim 1, wherein wherein R¹ is poly(N,N-dimethylamino methacrylate) (PDMAEMA);
curing the applied polymer to form a crosslinked coating, and
quaternizing R¹ to provide an antimicrobial moiety.

37. A kit comprising:
uncured coating precursor comprising bifunctional LASQ of Formula 1 of claim 1, optionally ladder-like polysilsesquioxane (LASQ), and
instructions to cure the mixture.

38.-40. (canceled)

41. The polymer of formula 1 of claim 1, where x is 0 to 1.

42. The method of claim 35, wherein the bifunctional LASQ comprises PDMS.

43. (canceled)

44. The polymer of claim 1, wherein the polymer of formula 1 is 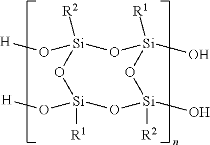
where R¹ 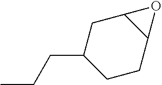
and R² is [chemical structure]
